(19) United States
(12) Patent Application Publication
(10) Pub. No.: US 2015/0235562 A1
(43) Pub. Date: Aug. 20, 2015

(54) WELLNESS AND WEIGHT MANAGEMENT SYSTEM AND METHOD

(71) Applicant: ELENCEE, INC., Fort Lauderdale, FL (US)

(72) Inventor: Laura Klein, Fort Lauderdale, FL (US)

(73) Assignee: ELENCEE, INC., Fort Lauderdale, FL (US)

(21) Appl. No.: 14/434,854

(22) PCT Filed: Oct. 10, 2013
(86) PCT No.: PCT/US2013/064223

§ 371 Date: Apr. 10, 2015

Related U.S. Application Data
(63) Continuation-in-part of application No. 13/662,594, filed on Oct. 29, 2012, now Pat. No. 8,777,624.
(60) Provisional application No. 61/713,219, filed on Oct. 12, 2012.

(51) Int. Cl. G09B 5/02; G09B 19/00

(52) U.S. Cl. CPC G09B 5/02; G09B 19/0092

(57) ABSTRACT

A process for improving human wellness that includes the steps of receiving at a processing device at least one input based on at least one of a user consumed food, a user activity, and a user behavior, relating a value to each of said at least one input, each value being one of a positive, a negative and a neutral value and derived by a diminishing return calculation that assigns a value to an nth occurrence of the at least one input that has a sign opposite to a value assigned to a first occurrence of the at least one input, calculating, based on each value, a total credit value, and causing the processing device to display a value related to the total credit value.

### CROSS-REFERENCE TO RELATED APPLICATION

This application is a §371 national phase application of PCT/US 13/64223, filed Oct. 13, 2013, which is a continuation-in-part of U.S. patent application Ser. No. 13/662,594, filed Oct. 29, 2012, which claims the benefit of U.S. Provisional Patent Application No. 61/713,219, filed Oct. 12, 2012; the prior applications are herewith incorporated by reference in their entirety.

### FIELD OF THE INVENTION

The present invention relates generally to a wellness and weight management method and software application, and more particularly relates to a wellness and weight management method, program, and software application configured to simplify the process of tracking user food consumption, activities, and behaviors affecting healthy and unhealthy lifestyle decisions.

### BACKGROUND OF THE INVENTION

Weight loss or management systems that commonly pair with software that track each food item consumed to calculate the number of calories consumed by the user. These weight loss systems advance the notion that simply limiting a person's food consumption in relation to their energy expenditure will result in weight loss. Typically, a person's diet is recognized as vital to a person's healthy well-being. It is further recognized that sleep, stress levels, smoking and activity levels, to name a few, factor into a person's wellness and resulting weight loss. Common weight loss programs involve counting a person's caloric intake and advise simply ingesting a calorie value less than the total number of calories burned by that person in a typical day. A person burns energy, measured in calories, every day in order to stay alive. For example, a number of calories are burned during sleep determined by, for example, a person's height, age and weight. However, research is beginning to show that not all calories are created equally. The composition of the food, not just the caloric value, affects weight loss and overall health. For instance, table sugar is considered a simple carbohydrate with no additional nutritional value except providing energy or calories. When sugar is eaten, insulin levels increase in the body, which in turn allow cells to receive more glucose than may otherwise be needed. Glucose that enters the cells, but is not utilized or burned, is then stored as fat. Two cups of spinach, on the other hand, which has the same caloric value as one teaspoon of table sugar, has a different nutrient composition, more positively affecting a person's overall wellness and resulting weight loss. Spinach has very few simple carbohydrates and does not cause an insulin spike and resulting fat storage as does table sugar.

One well-known diet is based on points, wherein point values are assigned to each particular piece of food. The diet requires that the dieter, when the points are added together, not exceed a certain point value. The points relate to a formula which considers only the calories, fat, and fiber, not the nutritional value or wellness impact, of the food. Additionally, only positive point values are assigned. In other words, the score only moves up, but does not move down, and thus it is hard to determine individual setbacks. In addition, this particular diet is cumbersome and difficult to follow as it requires that the person determine the point value for each individual food item. These types of diets may seem insurmountable because the dieter may want to lose in excess of 50 pounds. Additionally, dieters become discouraged by limited food choices and it is hard to monitor human behaviors. In addition, this type of diet does not factor in behaviors and activities, other than physical activity. Furthermore, this type of diet requires the use of a traditional food log. Prior art systems for counting points and/or calories have a number of drawbacks.

It is generally established that calorie counters allow the tracking of the caloric intake of food items over a period of time in order to promote healthy food consumption choices. Calorie counters operate to allow users to enter each food item individually and very accurately monitor each calorie consumed throughout a period of time, such as a day, a week, or a month. However, it is impractical to use the prior food logs for logging food items and caloric intake over a prescribed period of time because tracking each individual calorie and/or point is cumbersome and time consuming. Specifically incumbent with the prior food logs is that users must riffle through a large index of food and drink items. For example, Calorie King.com provides a software application that features a “50,000+ food database” touted as the “largest and most comprehensive available.” The database allows the user to search for every possible food item.

Incumbent with the prior art, users must riffle through a large index of food and drink items. For example, if a user ate a hamburger, the user must manually type in hamburger or otherwise search among a large list. For further example, after the user narrows a search to hamburgers, the user must then determine from a large list the exact brand of hamburger to mark to the user's journal as consumed. In addition, there may be a multitude of hamburgers from the same brand; thus the user must further narrow the search to the particular hamburger within the brand. Furthermore, the list may include 100 different types of hamburgers for the user to choose from. This is painstaking and discourages many individuals from continuing to track their food items over the extended period of time that is necessary to receive benefit from logging food consumption and/or calorie intake. For this reason, the instant invention, in contrast to the prior art for tracking exact food items, allows the users to simplistically track impact items.

Moreover, traditional food logs have proven to be an ineffective strategy for weight loss when viewed in light of the ever enlarging waistlines of the human population. In fact, there are a number of shortcomings with traditional food logs. For example, it is impractical for people to precisely log every food item that is consumed in a typical day. It becomes particularly burdensome when eating at restaurants, because the portion size and ingredient list is not always readily available. Furthermore, food logging is tedious and time-consuming. For instance, in a particular point-based diet, the dieter must weigh and measure each and every food item for a precise calculation relating to every calorie consumed. Additionally, it is not immediately clear the portion of, for example, a 6 oz. serving of fish. Traditional food logs focus on calories and not the quality of foods consumed or the dietary recommendations of the individual dieter.

Yet despite the importance of behavioral activity to weight loss programs, the prior weight loss programs do not incorporate overall wellness factors for managing weight control and wellness. A far better approach would be to provide a simpler food log that allows for simplified and more convenient determination of what foods should be added to a food log than is otherwise possible with the prior food logs. In addition, the food log should display and measure an impact score based on the quality of food consumed instead of relying simply on the caloric value.

Therefore, in spite of existing dietary plans, a need exists to overcome the problems with the prior art as discussed above. Namely, a need exists for a system and method for wellness and weight control that provides feedback about impactful wellness behaviors as well as providing a convenient and simplistic ability to track daily health and wellness factors.

Therefore, a need exists to overcome the problems with the prior art as discussed above.

### SUMMARY OF THE INVENTION

The invention provides a wellness and weight management system and method that overcomes the hereinafore-mentioned disadvantages of the heretofore-known devices and methods of this general type. It is an object of the present invention to provide a wellness and weight management system, process, and application software that accommodates a wide variety of wellness goals, behaviors, dietary preferences, activity preferences, exercise preferences and body weight objectives.

It is an object of the present invention to provide a process for improving human wellness, the process including the step of electronically displaying an arrangement of a plurality of drag-and-drop impact group icons in a graphical workspace, at least one of the plurality of drag-and-drop impact group icons corresponding to at least one of a plurality of food items, a plurality of user behaviors, and a plurality of user activities. The graphical workspace defines an impact region that has a plurality of drop sections and is configured to receive the plurality of drag-and-drop impact group icons. To advantageously monitor and log inputs from a user, one of the drop sections receives a user selection of one of the plurality of drag-and-drop impact group icons. One advantageous feature of the process is for an impact factor value to be calculated based on which of the plurality of drop sections receives the user selection of the at least one of the plurality of drag-and-drop impact group icons. As discussed more fully below, “based on” refers to a functional result dependent on the specific drop section where the impact icon is received or other impact icons that are received in that, or other, drop section(s). After the impact factor value has been determined, an updated impact score is then determined based on the impact factor value. The updated impact score is used to achieve a target goal set by the user or by the system operating the process. The target goal represents a score that is indicative of improving human wellness.

In accordance with another embodiment of the present invention, the method includes electronically displaying the user selection of the at least one of the plurality of drag-and-drop impact group icons in the at least one of the plurality of drop sections.

In accordance with a yet one more feature of the present invention, the drop sections include a commercial food seller drop section and a non-commercial food seller drop section. This specific categorization effectuates a user's ability to quickly and effectively measure the impact value factor value for food choices that are prevalent for most users.

In accordance with a further feature of the present invention, the at least one of the plurality of impact group icons or drag-and-drop group icons correspond to at least one of a plurality of categorized food groups. Again, this advantageous categorization provides a user with the ability to quickly, effectively, and efficiently monitor of his or her lifestyle choices.

In accordance with another feature, an embodiment of the present invention includes displaying the updated impact score to the user.

In accordance with an additional feature, an embodiment of the present invention includes displaying a suggested impact group icon or drag-and-drop impact group icon for increasing the updated impact score. As discussed below, the updated impact score may also decrease or stay the same based on the particular drag-and-drop impact group icon that is placed into a drop section.

Weight loss or management systems that commonly pair with software that track each food item consumed to calculate the number of calories consumed by the user. These weight loss systems advance the notion that simply limiting a person's food consumption in relation to their energy expenditure will result in weight loss. Typically, a person's diet is recognized as vital to a person's healthy well-being. It is further recognized that sleep, stress levels, smoking and activity levels, to name a few, factor into a person's wellness and resulting weight loss. Common weight loss programs involve counting a person's caloric intake and advise simply ingesting a calorie value less than the total number of calories burned by that person in a typical day. A person burns energy, measured in calories, every day in order to stay alive. For example, a number of calories are burned during sleep determined by, for example, a person's height, age and weight. However, research is beginning to show that not all calories are created equally. The composition of the food, not just the caloric value, affects weight loss and overall health. For instance, table sugar is considered a simple carbohydrate with no additional nutritional value except providing energy or calories. When sugar is eaten, insulin levels increase in the body, which in turn allow cells to receive more glucose than may otherwise be needed. Glucose that enters the cells, but is not utilized or burned, is then stored as fat. Two cups of spinach, on the other hand, which has the same caloric value as one teaspoon of table sugar, has a different nutrient composition, more positively affecting a person's overall wellness and resulting weight loss. Spinach has very few simple carbohydrates and does not cause an insulin spike and resulting fat storage as does table sugar.

One well-known diet is based on points, wherein point values are assigned to each particular piece of food. The diet requires that the dieter, when the points are added together, not exceed a certain point value. The points relate to a formula which considers only the calories, fat, and fiber, not the nutritional value or wellness impact, of the food. Additionally, only positive point values are assigned. In other words, the score only moves up, but does not move down, and thus it is hard to determine individual setbacks. In addition, this particular diet is cumbersome and difficult to follow as it requires that the person determine the point value for each individual food item. These types of diets may seem insurmountable because the dieter may want to lose in excess of 50 pounds. Additionally, dieters become discouraged by limited food choices and it is hard to monitor human behaviors. In addition, this type of diet does not factor in behaviors and activities, other than physical activity. Furthermore, this type of diet requires the use of a traditional food log. Prior art systems for counting points and/or calories have a number of drawbacks.

It is generally established that calorie counters allow the tracking of the caloric intake of food items over a period of time in order to promote healthy food consumption choices. Calorie counters operate to allow users to enter each food item individually and very accurately monitor each calorie consumed throughout a period of time, such as a day, a week, or a month. However, it is impractical to use the prior food logs for logging food items and caloric intake over a prescribed period of time because tracking each individual calorie and/or point is cumbersome and time consuming. Specifically incumbent with the prior food logs is that users must riffle through a large index of food and drink items. For example, Calorie King.com provides a software application that features a “50,000+ food database” touted as the “largest and most comprehensive available.” The database allows the user to search for every possible food item.

Incumbent with the prior art, users must riffle through a large index of food and drink items. For example, if a user ate a hamburger, the user must manually type in hamburger or otherwise search among a large list. For further example, after the user narrows a search to hamburgers, the user must then determine from a large list the exact brand of hamburger to mark to the user's journal as consumed. In addition, there may be a multitude of hamburgers from the same brand; thus the user must further narrow the search to the particular hamburger within the brand. Furthermore, the list may include 100 different types of hamburgers for the user to choose from. This is painstaking and discourages many individuals from continuing to track their food items over the extended period of time that is necessary to receive benefit from logging food consumption and/or calorie intake. For this reason, the instant invention, in contrast to the prior art for tracking exact food items, allows the users to simplistically track impact items.

Moreover, traditional food logs have proven to be an ineffective strategy for weight loss when viewed in light of the ever enlarging waistlines of the human population. In fact, there are a number of shortcomings with traditional food logs. For example, it is impractical for people to precisely log every food item that is consumed in a typical day. It becomes particularly burdensome when eating at restaurants, because the portion size and ingredient list is not always readily available. Furthermore, food logging is tedious and time-consuming. For instance, in a particular point-based diet, the dieter must weigh and measure each and every food item for a precise calculation relating to every calorie consumed. Additionally, it is not immediately clear the portion of, for example, a 6 oz. serving of fish. Traditional food logs focus on calories and not the quality of foods consumed or the dietary recommendations of the individual dieter.

Yet despite the importance of behavioral activity to weight loss programs, the prior weight loss programs do not incorporate overall wellness factors for managing weight control and wellness. A far better approach would be to provide a simpler food log that allows for simplified and more convenient determination of what foods should be added to a food log than is otherwise possible with the prior food logs. In addition, the food log should display and measure an impact score based on the quality of food consumed instead of relying simply on the caloric value.

Therefore, in spite of existing dietary plans, a need exists to overcome the problems with the prior art as discussed above. Namely, a need exists for a system and method for wellness and weight control that provides feedback about impactful wellness behaviors as well as providing a convenient and simplistic ability to track daily health and wellness factors.

In accordance with a further feature of the present invention, the suggested impact group icon is at least one of the plurality of food items, the plurality of user behaviors, and the plurality of user activities.

In accordance with another feature, an embodiment of the present invention includes displaying a maximum available impact factor value, corresponding to a user-selected impact group icon, for increasing the updated impact score. Said another way, the method may include displaying a suggested drag-and-drop impact group icon for maximizing, or obtaining the maximum value for, the updated impact score.

In accordance with an additional feature, an embodiment of the present invention includes displaying, after the updated impact score is determined, a suggested impact group icon corresponding to a maximum impact factor value. Moreover, the process may include displaying a maximum available impact factor value for increasing the updated impact score, the maximum available impact factor value based on an amount of the plurality of drag-and-drop impact group icons received in the at least one of the plurality of drop sections. In further embodiments, the process may include displaying a recommended serving or recommended amount of a particular impact group icon (associated with a behavior, food, activity, drink, etc.) that is going to be placed into a drop section, the recommended serving or amount corresponding to an optimum health impact that may optimally increase the updated impact score or some other standard as described in more detail below. For example, a user's recommended serving of protein may be 2 servings per day and when the user drags-and-drops an icon in a drop section the user will see that “2 servings” are “recommended.” Said further, the recommended daily serving of food, activity, behavior of a particular group icon is predetermined by a standard for user intake. Further, the process may alert a user that he or she is going over a recommended serving or amount, such that the placement of the icon in a drop section will reduce the updated impact score or otherwise have a negative impact. It should be noted that a “maximum” impact factor is the most credits or points a user can earn for a chosen icon.

In accordance with the present invention, a method for improving wellness is also disclosed that includes: (1) providing a user with access to view a plurality of impact group icons in a user interface, at least one of the plurality of impact group icons corresponding to at least one of a plurality of food items, a plurality of user behaviors, and a plurality of user activities, (2) selecting the at least one of the plurality of impact group icons for receipt into at least one of a plurality of drop sections defined by an impact region, the impact region defined in a graphical workspace on the user interface, (3) associating the at least one of the plurality of impact group icons with the at least one of the plurality of drop sections, (4) electronically displaying the at least one of the plurality of impact group icons in the at least one of the plurality of drop sections, (5) determining an impact factor value based on which of the at the least one of the plurality of drop sections receives the at least one of the plurality of impact group icons, and (6) determining, based on the impact factor value, an updated impact score.

In accordance with the present invention, a method for improving wellness is also disclosed that encompasses: (1) displaying a search bar in a graphical workspace, the search bar configured to receive a user input, (2) electronically receiving the user input in the search bar, the user input corresponding to the at least one of a plurality of food items, a plurality of user behaviors, and a plurality of user activities, (3) populating an item list, based on the user input, for display to a user, (4) presenting the item list to the user, the item list including a plurality of drag-and-drop impact group icons configured for movement by the user, the plurality of drag-and-drop impact group icons corresponding to at least one of the plurality of food items, the plurality of user behaviors, and the plurality of user activities, (5) defining an impact region in the graphical workspace, the impact region having a plurality of drop sections, the impact region configured to receive the plurality of drag-and-drop impact group icons, (6) receiving at least one the plurality of drag-and-drop impact group icons in at least one of the plurality of drop section, (7) an impact factor value based on which of the at the least one of the plurality of drop sections receives the at least one of the plurality of drag-and-drop impact group icons, and (8) determining, based on the impact factor value, an updated impact score.

Although the invention is illustrated and described herein as embodied in a wellness and weight management method, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. As used herein, the term “into” or “onto” may be used interchangeably as it relates to the drag-and-drop feature of the present invention.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is an elevational view of the front face of a mobile device displaying an exemplary weight and health management application, in accordance with the principles of the present invention;

FIG. 2 is an elevational view of the front face of a mobile device featuring a graphical user interface displaying results of the application after the user selects “EAT” in accordance with the principles of the present invention;

FIG. 3 is an elevational view of the front face of a mobile device featuring a graphical user interface displaying results of the application after the user selects “DO” in accordance with the principles of the present invention;

FIG. 4 is an elevational view of the front face of a mobile device featuring a graphical user interface displaying results of the application after the user selects “BE” in accordance with the principles of the present invention;

FIG. 5 is an elevational view of the front face of a mobile device featuring a graphical user interface displaying results of the application after the user selects “Add Food,” from the menu shown in FIG. 2 in accordance with the principles of the present invention;

FIG. 6 is an elevational view of the front face of a mobile device featuring a graphical user interface prompting the user to select food and drink items in accordance with the principles of the present invention;

FIG. 7 is an elevational view of the front face of a mobile device featuring a graphical user interface displaying food group choices in accordance with the principles of the present invention;

FIG. 8 is an elevational view of the front face of a mobile device featuring a graphical user interface displaying exemplary user selections in accordance with the principles of the present invention;

FIG. 9 is an elevational view of the front face of a mobile device featuring a graphical user interface receiving an input that a drink should be added in accordance with the principles of the present invention;

FIG. 10 is an elevational view of the front face of a mobile device featuring a graphical user interface displaying a selectable sub-menu for specifying drinks after the selection shown in FIG. 9 in accordance with the principles of the present invention;

FIG. 11 is an elevational view of the front face of a mobile device featuring a graphical user interface displaying a selectable menu of drink choices in accordance with the principles of the present invention;

FIG. 12 is an elevational view of the front face of a mobile device featuring a graphical user interface displaying a selectable menu featuring IF Values in accordance with the principles of the present invention;

FIG. 13 is an elevational view of the front face of a mobile device featuring a graphical user interface displaying items available for selective determination in accordance with the principles of the present invention;

FIG. 14 is an elevational view of the front face of a mobile device featuring a graphical user interface displaying IF Values and their accumulation in accordance with the principles of the present invention;

FIG. 15 is an elevational view of the front face of a mobile device featuring a graphical user interface allowing a user to add an activity in accordance with the principles of the present invention;

FIG. 16 is an elevational view of the front face of a mobile device featuring a graphical user interface allowing a user selection of “Exercise” after the user selects “Add Activity” as shown in FIG. 15 in accordance with the principles of the present invention;

FIG. 17 is an elevational view of the front face of a mobile device featuring a graphical user interface allowing a user selection of intensity level after the user adds an activity as shown in FIG. 16 in accordance with the principles of the present invention;

FIG. 18 is an elevational view of the front face of a mobile device featuring a graphical user interface allowing a user selection of a length of intensity after the user adds an activity as shown in FIG. 16 in accordance with the principles of the present invention;

FIG. 19 is an elevational view of the front face of a mobile device featuring a graphical user interface allowing a user selection of IF Values in accordance with the principles of the present invention;

FIG. 20 is an elevational view of the front face of a mobile device featuring a graphical user interface allowing a user selection of activities for IF Values assigned in accordance with the principles of the present invention;

FIG. 21 is an elevational view of the front face of a mobile device featuring a graphical user interface displaying a particular activity item from FIG. 20 for IF Value determination in accordance with the principles of the present invention;

FIG. 22 is an elevational view of the front face of a mobile device featuring a graphical user interface displaying a summary in accordance with the principles of the present invention;

FIGS. 23-26 are elevational views of the front face of a mobile device featuring a graphical user interface displaying selections of an Activity in accordance with the principles of the present invention;

FIG. 27 is a block diagram of an exemplary weight management system that shows a smartphone device in digital communication with a server in accordance with the principles of the present invention;

FIG. 28 is an exemplary screen shot of a drag-and-drop weight management tool selection entry screen in accordance with the principles of the present invention;

FIG. 29 is an exemplary screen shot of the drag-and-drop weight management tool selection entry screen of FIG. 28 in accordance with an embodiment of the present invention;

FIG. 30 is a process flow diagram depicting the functionality of the drag-and-drop weight management tool selection screen of FIGS. 28-29 in accordance with the principles of the present embodiment;

FIG. 31 is a process flow diagram depicting the functionality of the weight management tool selection screen of FIGS. 28-29 in accordance with another embodiment of the present invention;

FIGS. 32-35 are exemplary screen shots depicting various drag-and-drop user-movements within a weight management tool application in accordance with an embodiment of the present invention; and

FIGS. 36-38 are exemplary screen shots depicting a search result and various drag-and-drop user-movements from the search result within a weight management tool application in accordance with an embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient wellness and weight management system, method, and software application that calculates and provides feedback to a user for achieving particular wellness and weight management goals.

Accordingly, it is an object of the present invention to provide a program that encourages healthy behaviors and actions through feedback from user inputs that include both healthy and unhealthy: (1) foods, (2) user activities, and (3) user behaviors. The invention provides credits having either positive, negative, or neutral values based on the wellness impact of the person's behaviors. The credits are provided for foods (including drinks), activities, and/or certain behaviors. It is particularly useful to use credits, having positive and negative values, to provide instant user feedback as to the positive or negative effect of the food, activity and behavior choices that the user is making Additionally, there may be a timeframe for which to reach a particular credit total, such as over the course of a day, week, month, or year. However, negative choices may reduce the particular credit total. Too many negative choices may result in that person missing the credit total goal.

It is a further object of the present invention to provide a process for wellness and body weight management in a human being. The process includes grouping impactful behaviors, impactful activities, and impactful foods (“Impact Groups” or “IG”) based on similarities and wellness impacts for which that behavior, activity, and/or food has on the risk of disease, cancer, health conditions, body weight, and others.

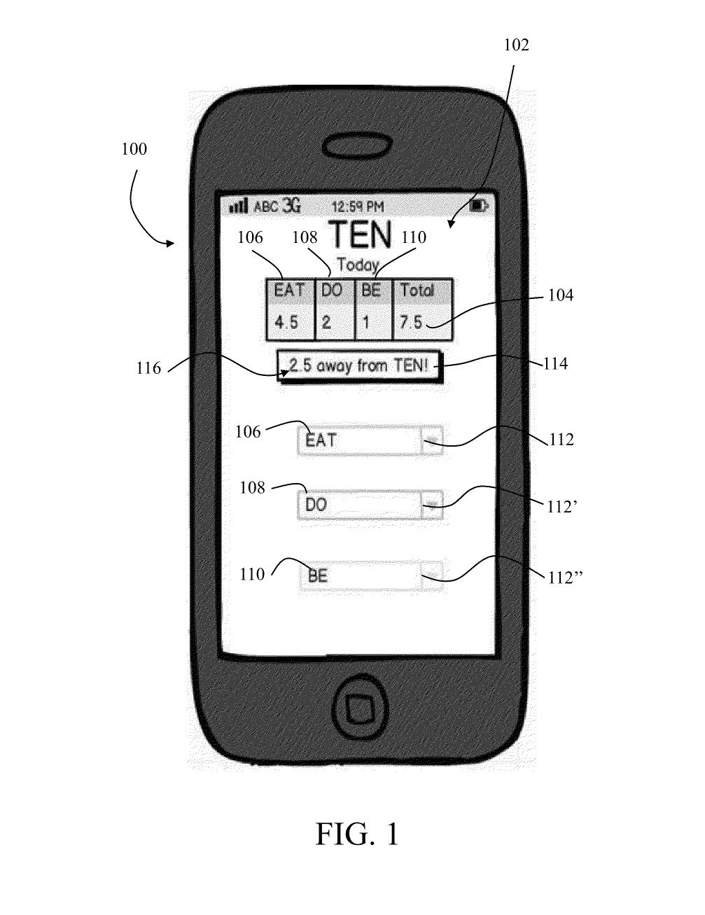

FIG. 1 provides an elevational view of the front face of a computing device 100. In this case, a mobile phone is shown, but the invention is in no way limited to any particular device and can include laptop computers, desktop computers, tablets, and other similar computing devices. The computing device 100 displays a novel weight and health management application 102 that operates in accordance with the principles of the present invention. The wellness application 102 may be a software program installed on the computing device 100. Alternatively, the wellness application 102 may be a web-based program utilized through an internet browser on the computing device 100. The wellness application 102 provides user feedback relating to overall wellness. The feedback may include, for example, a negative, neutral, or positive overall wellness value.

Impact Factor Value(s) (“IF Value(s)”) are calculated in accordance with certain embodiments of the present invention. Any particular IF Value may be a real number having a positive, negative, and/or no value including whole numbers, integers and rational numbers. In an embodiment, the IF Value=R+P wherein R is defined as the relationship to overall wellness impact and wherein P is defined as the likelihood of the average person performing the behavior. R may be any positive, negative or neutral value and may further indicate a strongly positively related, strongly negatively related, weakly positively related, weakly negatively related, or neutral relationship to overall wellness. P may be any positive, negative or neutral value. The IF Values should encourage or discourage a person performing the behavior in order to accumulate an Impact Score towards attaining the daily goal.

As shown in FIG. 1, the IF Values can be added together to derive the total credits earned, which is graphically displayed on the computing device 100 in field 104. The total credits earned 104 define an “Impact Score” wherein the Impact Score relates to the impact that food, activities, and behaviors will have on the health and wellness of the user. The Impact Score may be any known value or numbering designation, or may be any other indicia of indicating improvement or declination based on a user's inputted IF Values. The IF Values may vary depending on previous IF Values earned. For example, boundaries exist where additional behaviors in the same IG have incrementally diminishing returns. Alternatively, boundaries exist where additional behaviors in the same IG have incrementally expanding returns. For example, a user who eats fast food may lose zero point five (0.5) credits for a first visit to a fast food establishment in a particular time period. However, a user that eats fast food may lose one (1) credit for a second visit to the fast food establishment in that same time period, thus resulting in a total of one point five (1.5) credits to be subtracted from the total credits earned 104 during a particular tracking duration. Additionally, the total distance 116 away from the target goal 114 will increase in relation to the Impact Score. In a particular embodiment, the target goal 114 is to reach a total of ten (10) credits in a specific period of time. However, it is appreciated that any credit value may be the target goal 114.

In yet another example, alcoholic drinks, such as wine and/or beer, may include a positive IF Value for providing a positive credit to the total earned credits 104 because alcoholic drinks are known to have positive health benefits when consumed in small quantities and in moderation, wherein the IF Value provides incrementally diminishing returns as quantities of alcoholic drinks increase beyond a healthy level. Thus, while a first alcoholic drink may provide a positive IF Value, the IF Value may decrease to zero (0), i.e., a neutral value, or alternatively may be a negative value, such as negative one (−1) credit acting to reduce the total earned credits, Impact Score, for at least one particular time period. Alternatively, a first alcoholic drink may provide for a neutral value of zero (0) and additional alcoholic drinks may be assessed a negative value. Additionally, certain activities may have a greater IF Value when typically performed less often. For example, a user who flosses their teeth (e.g., an impact activity) often may receive less value for an individual flossing session than an individual who rarely flosses.

The target goal 114 may be in relation to a daily goal, weekly goal, monthly goal or yearly goal or any other specified duration. Additionally, the application 102 may display a plurality of target goals 114. The goals may relate to a variety of goals, such as a weekly, monthly and/or yearly goal. As an example, a first daily target goal is provided for a ten (10) credit value and a second thirty (30) day goal is provided for a three hundred (300) credit value. The credit value for any target goal may be of any value.

Particular IF Values may be associated with behaviors that relate to a specific disease state or condition, such as Type 2 Diabetes, Cardiovascular Disease, Arthritis or Allergies.

Groups may be associated with particular food groups. Food groups may be any determined grouping of individualized food items. Alternatively, groups may be arranged in relation to the United States Department of Agriculture, USDA, recognized food groups, such as fruits, vegetables, proteins, grains, and dairy.

Behaviors may be defined as any type of human behavior that affects overall wellness and/or weight management.

A serving size may be related to a conventional serving size based on weight, volume, or other known serving size(s). Alternatively, a serving size may be determined based on a generic serving size. For example, the serving size may relate to the size of the user's fist, as the size of a user's fist has been found to generally correlate to a proper serving size in relation to the IF values. For example, a small female having a small fist needs a smaller serving size than a large male having a large fist in order to positively affect health and wellness. A serving size may be defined as any size serving capable of being accurately or approximately measured and/or quantified.

Impact Groups may include a particular threshold value for which IF Values have a predetermined maximum threshold. For example, an activity, such as sleep, may have a maximum IF Value capable of providing credits towards the total earned credits 104.

Referring now to FIG. 1, one embodiment of the present invention is shown. FIG. 1 shows several advantageous features of the present invention, but, as will be described below, the invention can be provided in several shapes, sizes, combinations of features and components, and varying numbers and functions of the components. FIG. 1 depicts a computing device 100 such as a smartphone, tablet, or any other computing device. The computing device 100 is capable of running a wellness application 102. The information from the wellness application 102 is configured to be displayed on a display screen 115 of the computing device 100.

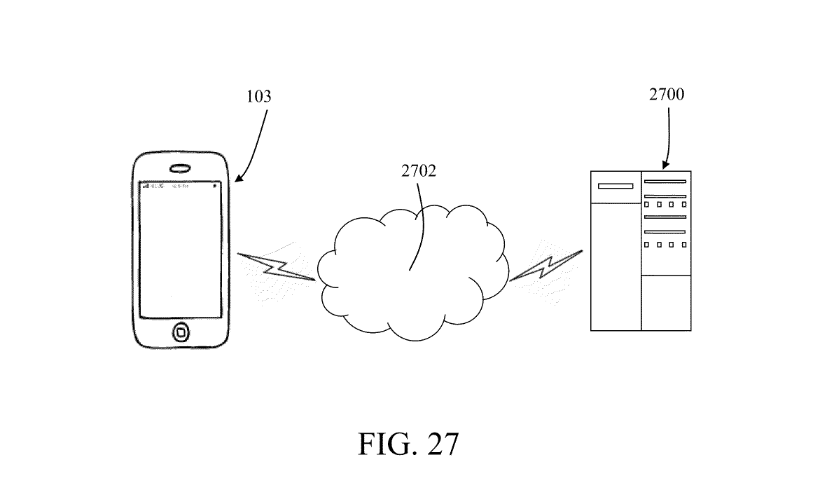

In a preferred embodiment, the application 102 is run locally on computing device 100. The information may be stored locally on computing device 100 or stored in a server 2700 (shown in FIG. 27) or both. Information stored in a cloud-based server or any other type of server may be communicated across any type of network 2702, such as the Internet, capable of permitting communication between the computing device 100 and the server 2700. Alternatively, the wellness application 102 may be run remotely from server 2700.

Returning to FIG. 1, the wellness application 102 is configured to display the total earned credits 104. In an embodiment, the total earned credits 104 is made up of a combination of earned credits from EAT 106, DO 108 and BE 110. EAT 106 relates to the food and drinks consumed by the user. DO 108 relates to the activities performed by the user. BE 110 relates to the behaviors experienced and/or exhibited by the user.

The wellness application provides a target goal field 114. The target goal field 114 provides a number or other indicator for which the user aims to achieve. In a particular example, the target goal may include of any combination of credits earned from EAT 106, DO 108, and BE 110, wherein the user may reach the target goal from credits from any combination of EAT 106, DO 108, and BE 110. For instance, the goal may be reached by earning credits only from food items in EAT 106. Further example, the combination of credits from EAT 106, DO 108, and BE 110 may be combined to reach the target goal. A credit total is adjusted, and displayed as adjusted on the display screen, in relation to changes to the total earned credits 104. As the total earned credits 104 moves up or down, the credits needed to achieve the target goal in field 114 moves proportionally, either in real-time or later in time. In one embodiment, the target goal does not fluctuate in value. For example, when the target goal is ten (10) credits, the goal will be achieved by accumulating credits that add up to the ten credits. However, negative credits may reduce the value of the total earned credits, in which case, additional credits having a positive value are required to reach the ten credit goal. For instance, if negative four (−4) credits are earned in a particular time period, then fourteen (14) credits having a positive value must be earned to reach a target goal of ten (10) credits. While the target goal in this particular example is ten (10), any positive value may be used as the target goal.

The target goal may increase in value over time as the user progresses through the wellness program. For example, the user's target goal may increase based on a variety of factors such as a fluctuation in a user's weight. Alternatively the goal may increase after the user reaches the target goal a specified number of times. In another alternative, the goal may increase after a predetermined time period.

In another embodiment, the credits needed to reach the goal may fluctuate disproportionally in relation to the total earned credits 104. For example, the user earns one negative (−1) credit that is reflected in the total earned credits 104. As a result of earning one (1) negative credit, the total credits to reach the goal will increase by two (2) credits. In yet another embodiment, earning one (1) negative credit from EAT 106, DO 108, or BE 110 increases the total specific goal of EAT 106, DO 108, or BE 108 by two (2) credits, wherein only receiving credits from that specific group of EAT 106, DO 108, or BE 108, as specified, will permit the user to reach the target goal 114. For example, if the user eats out at a fast food restaurant, having an IF Value of negative one (−1) credit in the BE category, the specific goal, such as earning three (3) BE credits as part of the ten (10) total target goal 114, will increase to four (4) BE credits, wherein four (4) BE credits are then required to reach the target goal 114.

The invention further includes at least one selection 112 configured to allow the user to select a screen to add credits for EAT 106, DO 108, and BE 110. Then at least one selection 112 is additionally configured to permit adjustment of the Impact Score.

As depicted in FIG. 1, an embodiment provides three selection menus 112, 112′, 112″. The first selection menu 112 allows selection of EAT 106. EAT 106 is associated with food and drink items consumed by the user of the wellness application 102. Credits are associated with the consumption of food and drink items and associated IF Values. The second selection menu 112′ allows selection of DO 108. DO 108 is associated with activities of the user, wherein activities may include, inter alia, exercise, yoga, reading, sleeping, watching TV, playing video games, sitting at work, and other similar activities. The third selection menu 112″ allows selection of BE 110. BE 110 is associated with behaviors of the user, wherein behaviors may include, inter alia, eating breakfast, eating fast food, eating out, smoking and/or being in a state of stress. The behaviors may further include any and all attitude or emotion experienced by the user, such as, for example, happiness, sadness, and anger.

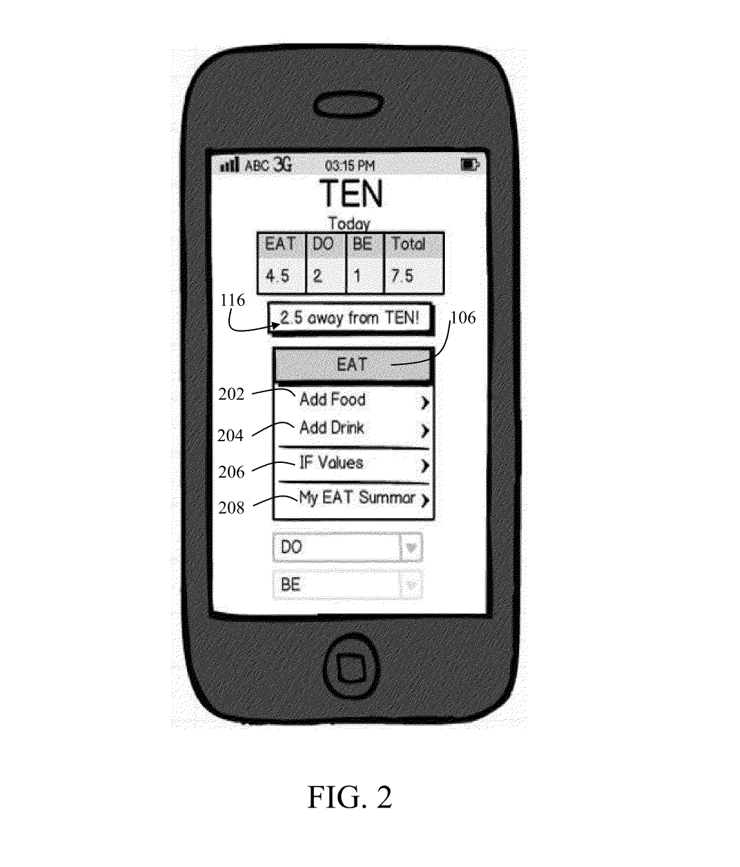

FIG. 2 is an elevational view of the front face of the mobile device 100 featuring a graphical user interface displaying results of the application 102 after the user selects “EAT” 106 in accordance with the principles of the present invention. Selecting EAT 106 allows the user to select between adding food 202 items or adding drink 204 items in order to affect the total credits earned 104, and further to affect the total credits earned toward reaching the target goal 114. A selection 206 for determining the IF Values is available, wherein choosing selection 206 allows the user to determine the value of credits to be awarded for a particular food or drink selection. The IF Values may be between any positive or negative number, including decimals. For example, eating an apple may earn the user zero point five (0.5) EAT 106 credits. For a further example, eating a fast food hamburger may earn the user negative zero point five (−0.5) credits. A food summary selection 208 for viewing a summary of foods consumed is available for providing feedback of the wellness impact of the foods consumed by the user.

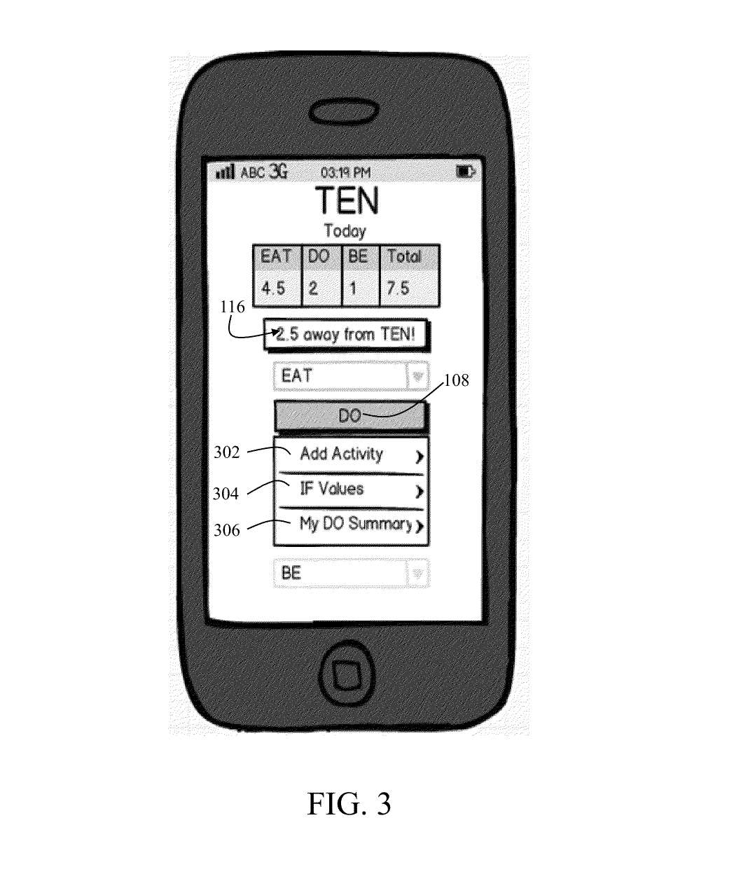

FIG. 3 is an elevational view of the front face of the mobile device 100 featuring a graphical user interface displaying results of the application 102 after the user selects “DO” 108 in accordance with the principles of the present invention. The selection 112′ of DO 108 allows the user to further select items, such as, adding an activity selection 302, IF Value determination selection 304 of the IF Values relating to a particular activity selection 302, and activity summary selection 306 for viewing a summary of DO 108. Activities 302 include particular activity items having a particular IF Value associated with them. Selection of a particular activity 302 affects the total credits earned 104 towards the target goal 114. The IF Value may be between any positive or negative number, including decimals. For example, exercising may earn the user one point five (1.5) credits, moving the user closer to the target goal 114. For another example, playing video games for a particular time period may earn the user negative two point five (−2.5) credits, moving the user further away from the target goal 114. The wellness application 102 may display, in any manner, the distance 116 from the target goal 114. For example, FIGS. 1-4 depict a box displaying a target goal 114 of ten (10) and further depicts a distance of two point five (2.5) credit distance 116 from the target goal 114. A selection 304 for determining the IF Values is available, wherein choosing selection 304 allows the user to look up the IF Value to be awarded for a particular DO 108 activity 302.

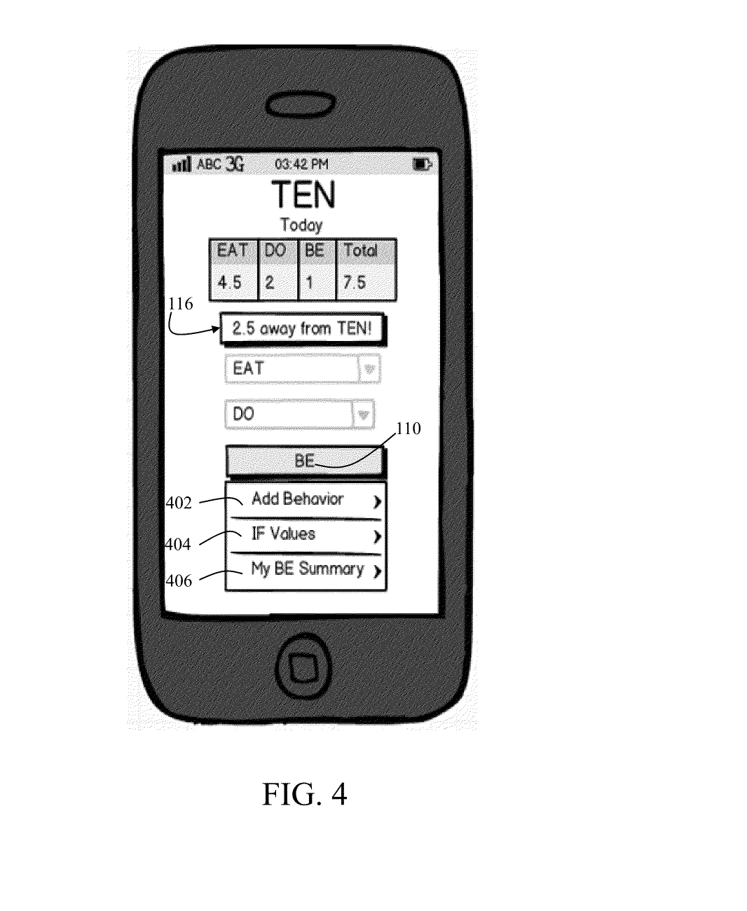

FIG. 4 is an elevational view of the front face of the mobile device 100 after the user selects “BE” 110 from the wellness application 102 in accordance with the principles of the present invention. The selection 112″ (from FIG. 1) of BE 110 allows the user to further select items, such as, add behavior selection 402 for adding a behavior 110, IF Value determination selection 404 for determining the IF Values relating to a selected behavior 402, and behavior summary selection 406 for viewing a summary of the individual behaviors 402 having a credit value. Selection of BE 402 allows for the selection of particular behaviors 402, such as eating breakfast, eating fast food, smoking and taking/not taking prescribed medications, among many other possible choices. Behaviors 402 additionally include human emotions such as stress, happiness, sadness and anxiety, each having at least a particular IF value associated to it. The IF credit value may be associated depending upon the level of the behavior. For example, if the individual is only mildly stressed, then the user may so indicate, wherein a particular value is associated thereof. User selection of a particular behavior affects the total credits earned 104 and the target goal 114. The IF Value may be between any positive or negative number, including decimals. For example, a user that indicates happiness may earn the user one point five (1.5) credits. For another example, a user that indicates stress may earn the user negative two point five (−2.5) credits. IF Value adjustment selection 404 for determining the IF Values is available, wherein choosing the IF Value selection 404 allows the user to look-up the value of credits to be awarded for a particular DO 108 activity.

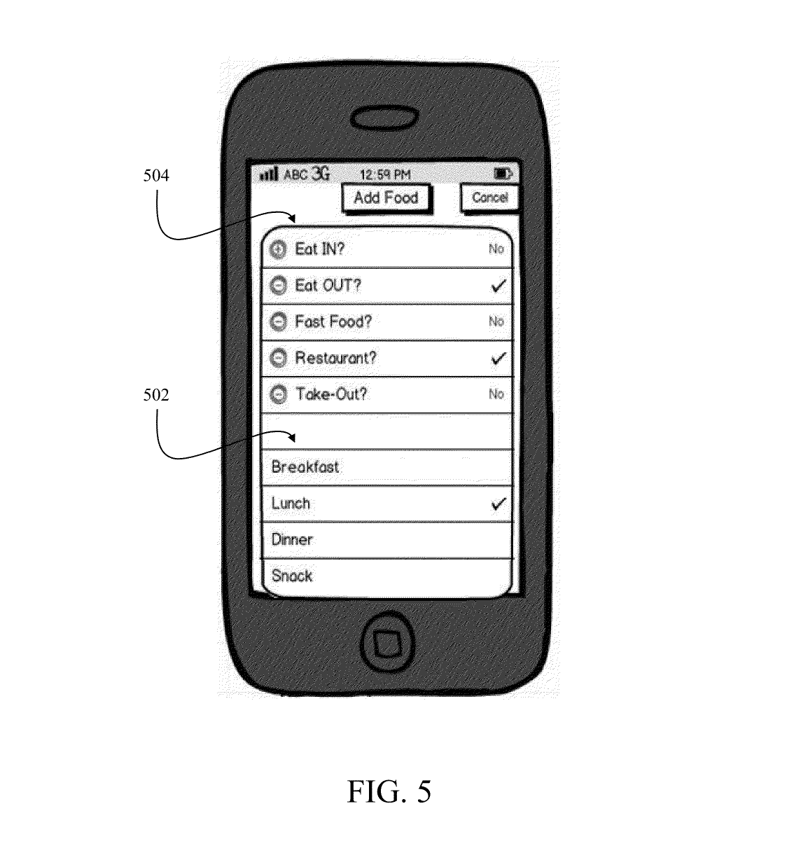

FIG. 5 is an elevational view of the front face of the mobile device 100 featuring the wellness application 102 that provides a graphical user interface displaying results of the application 102 after the user selects “Add Food,” 202 from the menu shown in FIG. 2 in accordance with the principles of the present invention. The application 102 allows user selection of various options. For example, the user may make a meal selection 502 to indicate whether a particular food or drink is consumed as breakfast, lunch, dinner, or as a snack. The timing of the food or drink item may affect the credit value associated. For example, consuming an apple at 12:30 am at night may be of less credit value than consuming an apple at 8:30 am. The time element associated with the food or drink consumption may be manually input by the user or may be synced and received from the device running the instant application 102. As an additional example, consuming a first apple for breakfast may be worth a particular credit value, whereas a second apple consumed for the same breakfast may be worth another particular credit value, but possibly not the same as the first credit and can even be negative. Further, the user may make a food location selection 504 that indicates whether a particular food item is associated with eating in, such as at home or a family and friends house, or eating out. Often times, home-cooked foods have higher nutritional value than restaurant foods. Additionally, the user may indicate whether the food is fast food or restaurant food. The user may further indicate whether the food was takeout or delivery. A particular credit value may be associated with eating in, whereas a different and likely lower credit value may be associated with eating out. Studies have shown that people who eat out often tend to be more overweight than those who don't eat out as often. Similarly, a particular credit value may be associated with fast food, restaurant food, take-out or delivery.

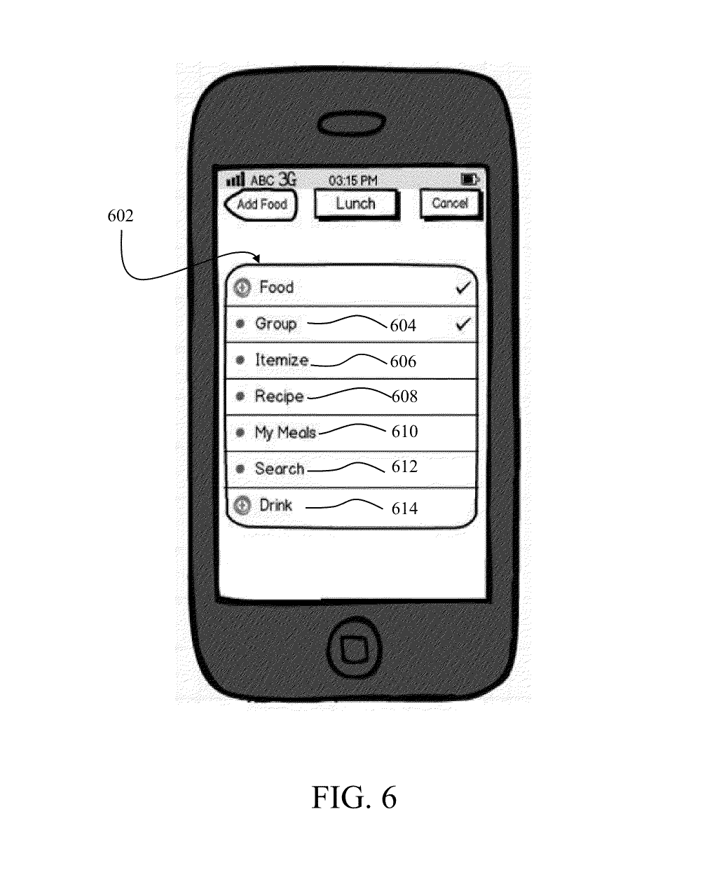

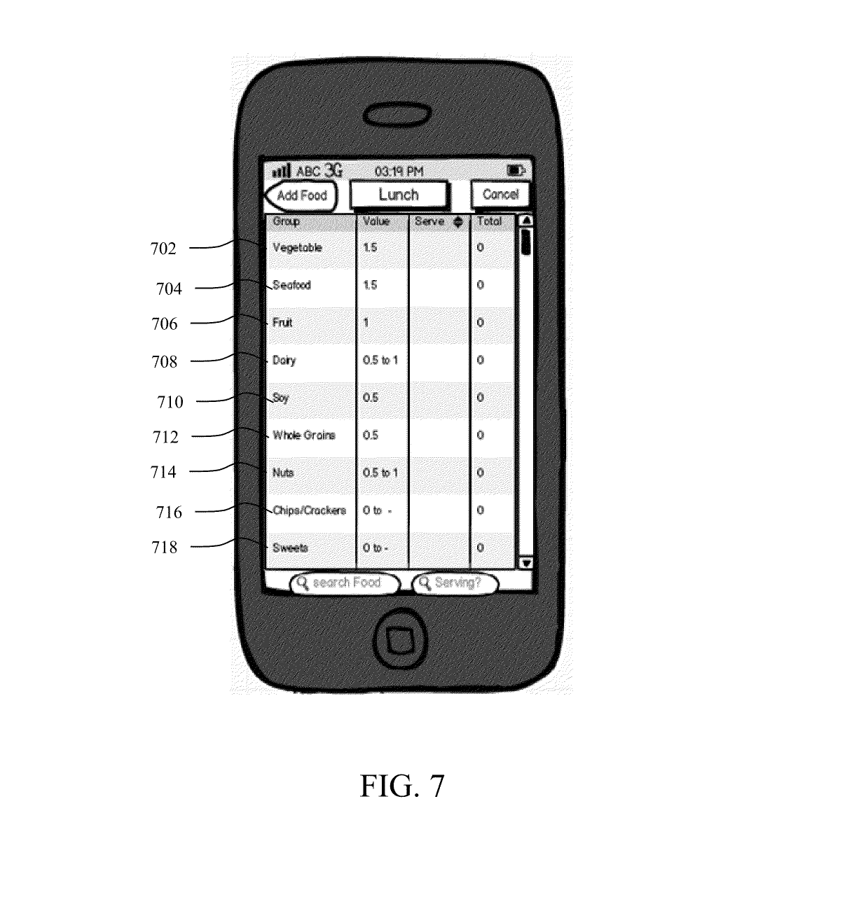

FIG. 6 is an elevational view of the front face of the mobile device 100 featuring the wellness application 102 that provides a graphical user interface prompting the user to select food and drink items. FIG. 6 depicts a selection 602 for laying out food or drink items. For example, user selection of Group 604 provides a list of foods sorted by group (as depicted in FIG. 7). Groups may include, inter alia, Vegetables 702, Seafood 704, Fruit 706, Dairy 708, Soy 710, Whole Grains 712, Nuts 714, Chips/Crackers 716, Sweets 718 and others. Selection of the itemized list input 606 will provide a further itemized list of individualized foods and drinks that are capable of selection by the user. Selection of the recipe input 608 will provide recipes formed from a combination of individual items, wherein the combination of the items have a particular IF Value represented by a particular recipe. The recipes can be maintained at a central database accessible through a network by a plurality of users. In this embodiment, a database manager is able to access each recipe and assign credit values based on aspects of the recipe that merit credit scores. In other embodiments, each recipe credit value can be assigned by the uploading user or by the receiving user. In addition, recipes can have different credit scores that depend on the ingredients, i.e., organic items score higher than non-organic, low salt ingredients score higher than salted items, etc.

Selection of the My Meals input 610 will provide a list of previously selected meals. Meals may include a plurality of separate food items that are grouped together to easily select multiple food items the user commonly eats during for a meal. A search selection input 612, when selected, permits the user to search a database for a particular food or drink item. A drink selection input 614 may be selected. The drink selection input 614, when selected, will provide a selection for further selection of a drink groups, itemized list of drinks, drink recipes, and drink search.

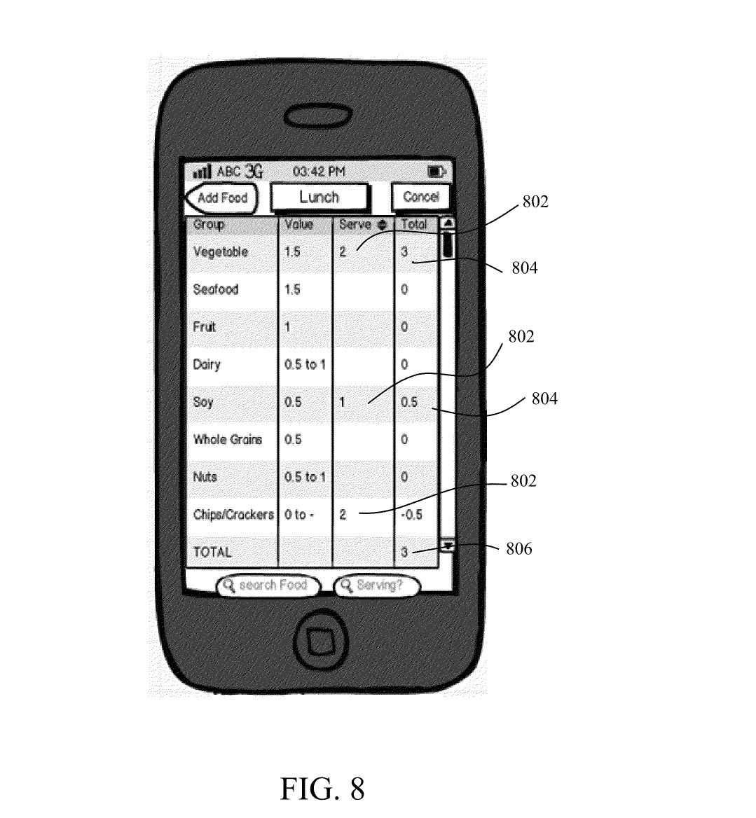

FIGS. 7 and 8 show the mobile device 100 illustrating screen shots generated from the wellness application 102, the screen permitting the selection of a particular food group item by a user. The user will input the serving size 802 for each particular item that is consumed by the user. An individual group credit value 804 is calculated based upon at least the IF Value from that particular food group and the serving size. The individual group credit value 804 is displayed on the computing device 100. Each individual group credit value 804 is added together and the total group credit value 806, which includes the summation from each individual group credit value 804, is displayed on the display of the computing device 100. Furthermore, the individual group credit value 804 is added to the total earned credits 104 (FIG. 1). Additionally, the item credit value will be subtracted from the target goal 114 (FIG. 1).

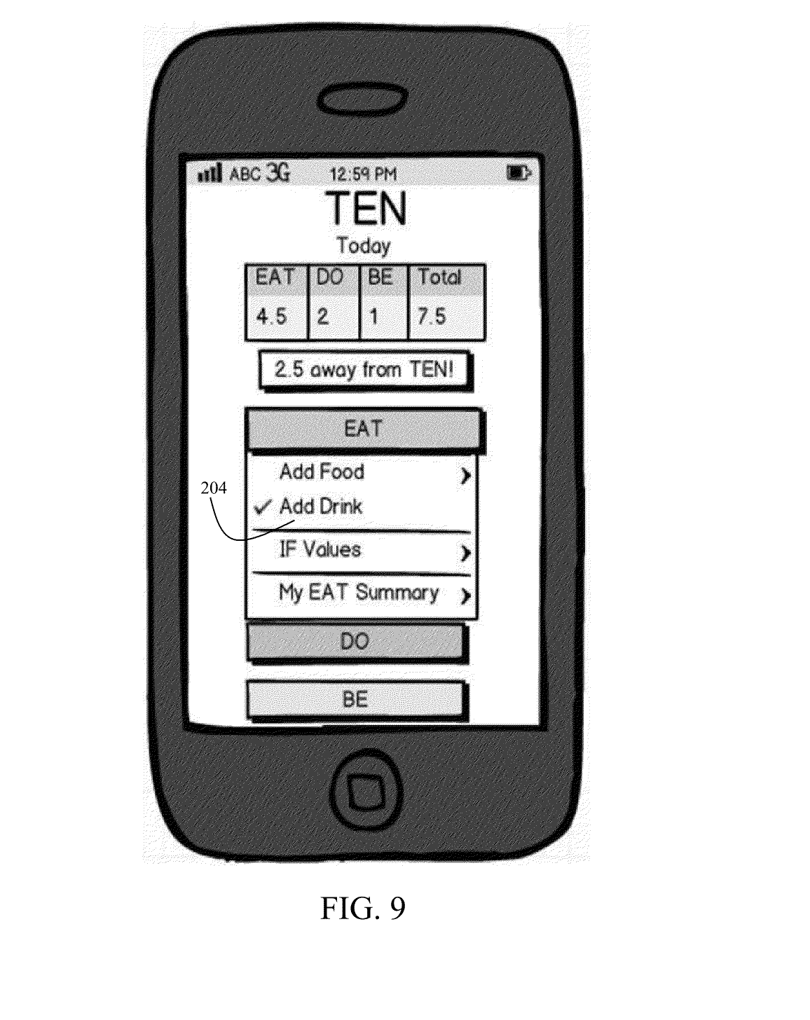

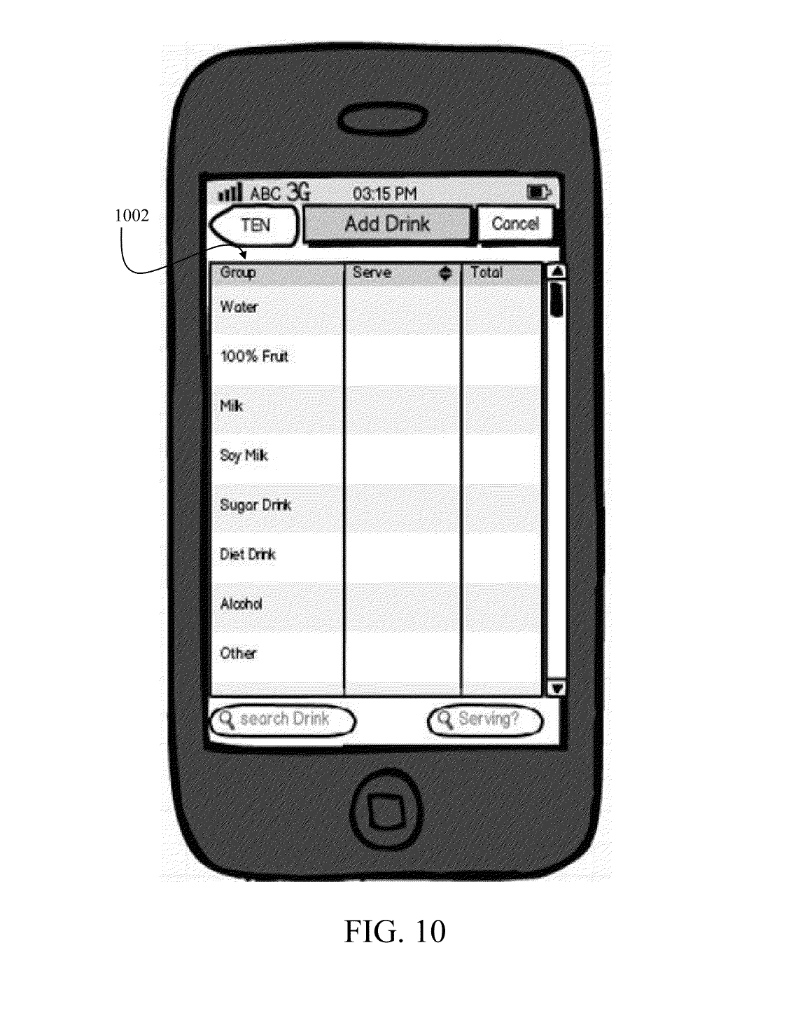

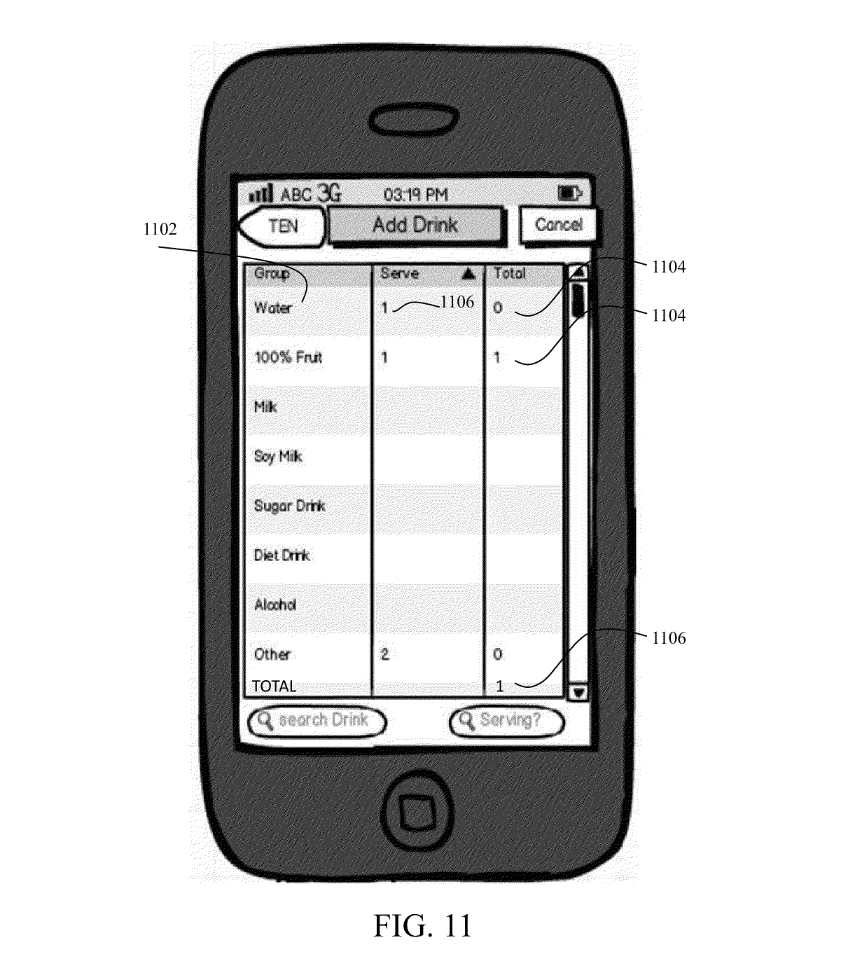

FIGS. 9-11 are elevational views of the front face of the mobile device 100 featuring the wellness application 102 generating a graphical user interface displaying results of the user selecting the “Add Drink” 204 selection from the menu shown in FIG. 2. The Add Drink 204 selection permits a user to choose a particular drink or beverage. From the user's selection of Add Drink 204, a listing of drinks is available for selection. These drinks, from a drink selection 1002 shown in FIG. 10 may include, inter alia, water, fruit juice, milk, soy milk, sugar drink, diet drink, alcohol or other types of drinks As one example, shown in FIG. 11, the user selects a drink such as water and further selects the serving size 1106. An individual drink credit value 1104 is calculated based upon at least the IF Value from that particular drink and serving size. The individual drink credit value 1104 is displayed the computing device 100. The total drink credit value 1106, which includes the summation from each individual drink credit value 1104 is displayed on the display 115 of the computing device 100. Furthermore, the individual drink credit value 1104 is added to the total earned credits 104, such as that shown in FIG. 1. Additionally, the drink credit value will be subtracted from the target goal 114.

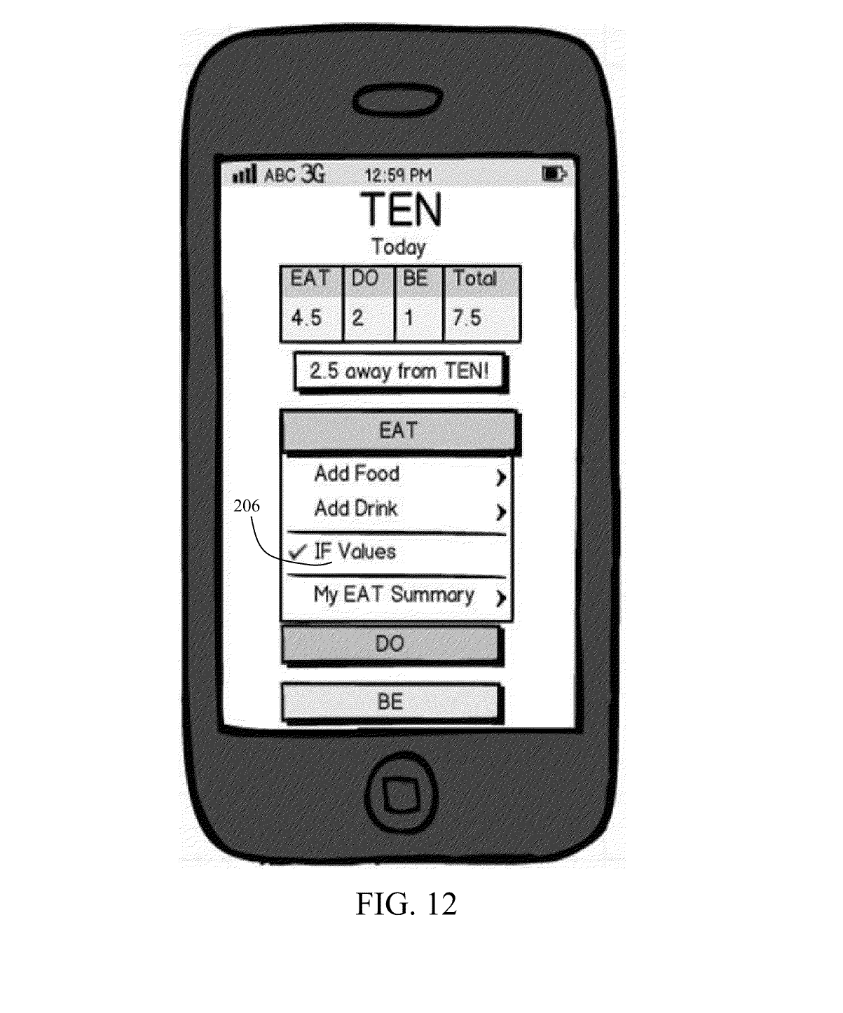

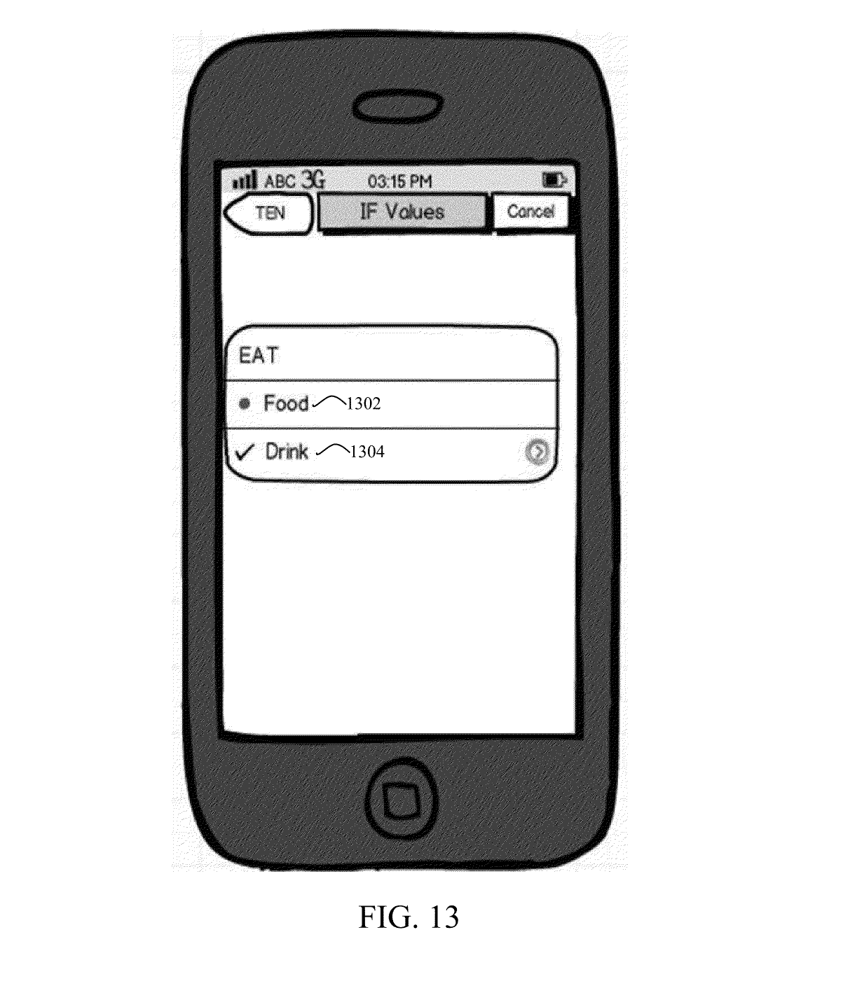

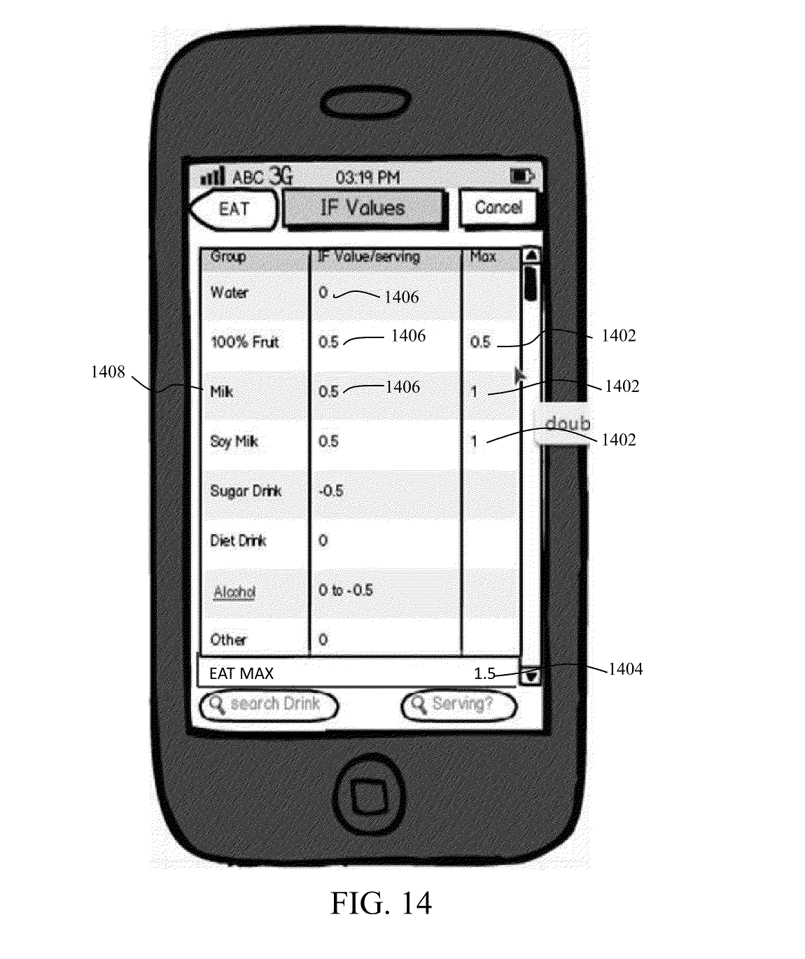

FIGS. 12-14 are elevational views of the front face of the mobile device 100 featuring the wellness application 102 generating a graphical user interface displaying a user selection and determination of IF Values. As such, the user is able to select or provide the IF values input 206 for the Food IF Values 1302 and/or Drink IF Values 1304, as shown in FIG. 13. As shown in FIG. 14, the IF value 1406 is the IF Value per serving. In one embodiment, the user may select a more than one serving, but the maximum IF Value to be credited towards the total credits earned 104 is only for the one serving. Additionally, the maximum IF value may impact the credits to be subtracted from the distance away from the target goal 116 for any particular food or drink consumed by the user. For example, as shown in FIG. 14, the maximum credits 1402 for drinking Fruit Juice, 100% Fruit, and Milk, is 0.5, 1, and 1 credits, respectively. As such, whether the user drinks more than one serving of Fruit Juice, the user can only earn a maximum of zero point five (0.5) credits for this behavior.

In operation, for exemplary purposes, the user may select milk 1408 which has zero point five (0.5) incremental IF Value 1406 per serving. Further, milk 1408 may be set to have a maximum of one (1) credit value 1402. When the user selects one serving of milk 1408, a credit value of zero point five (0.5) credits are added to the total credits earned 104. Additionally, zero point five (0.5) credits are subtracted from the distance away from the target goal 116 when the user selects that particular food item, drink item, or group item. When the user selects 5 servings of milk, for example, only one (1) credit value is added to the total credits earned 104 because the maximum serving was set to provide 1 total credit for milk. EAT 106, DO 108 and BE 110 may each be configured to have a maximum value 1402 and a corresponding cumulative maximum value 1404 for which the user may not exceed.

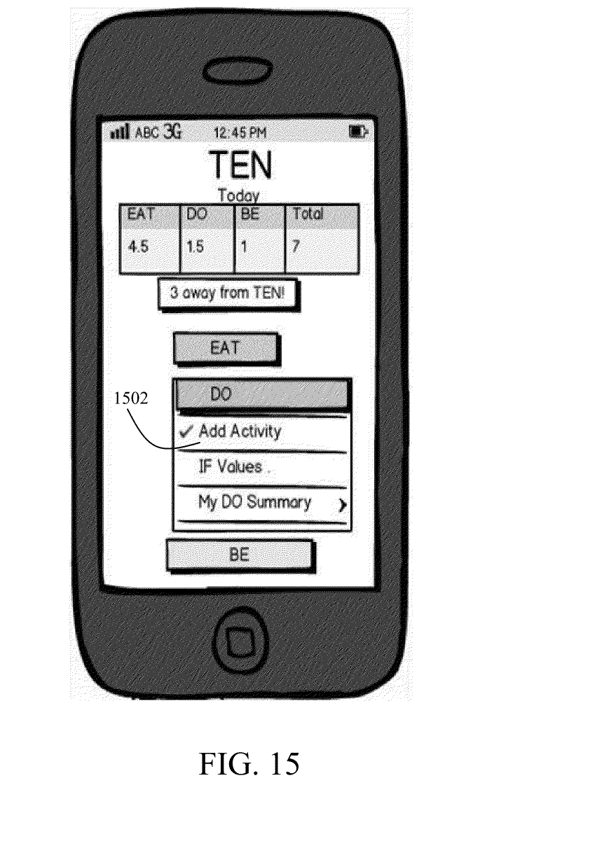

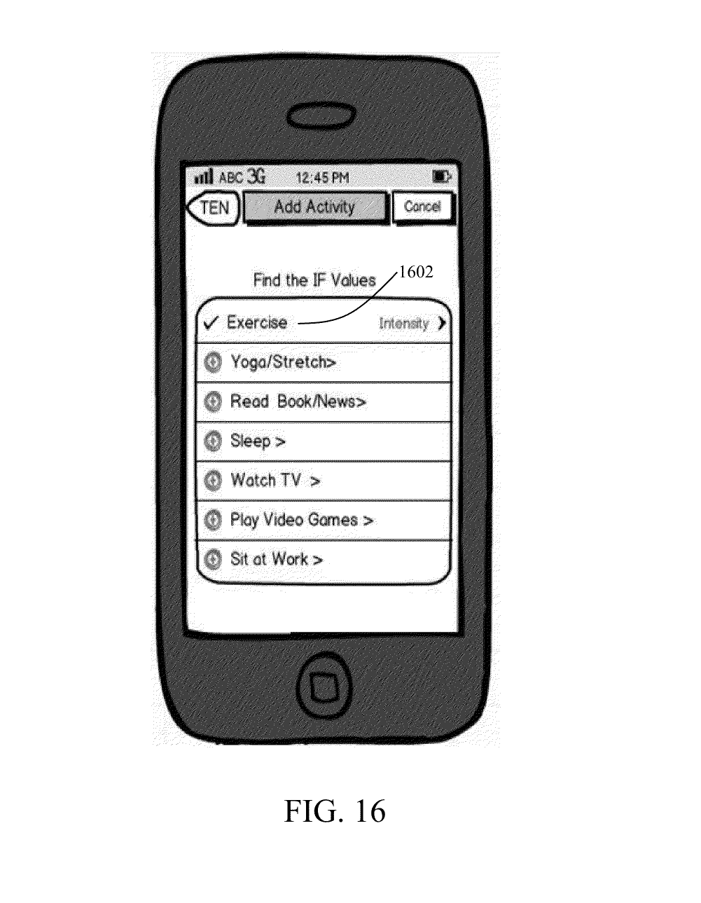

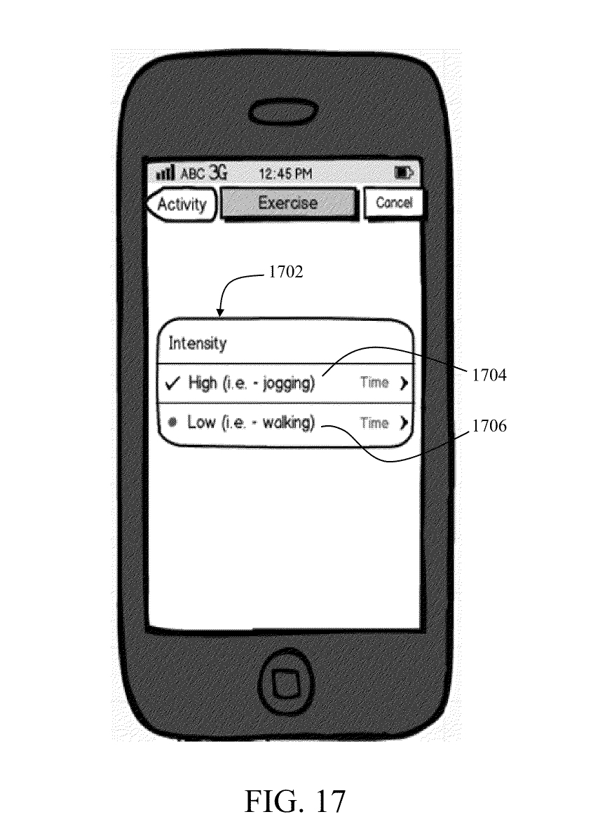

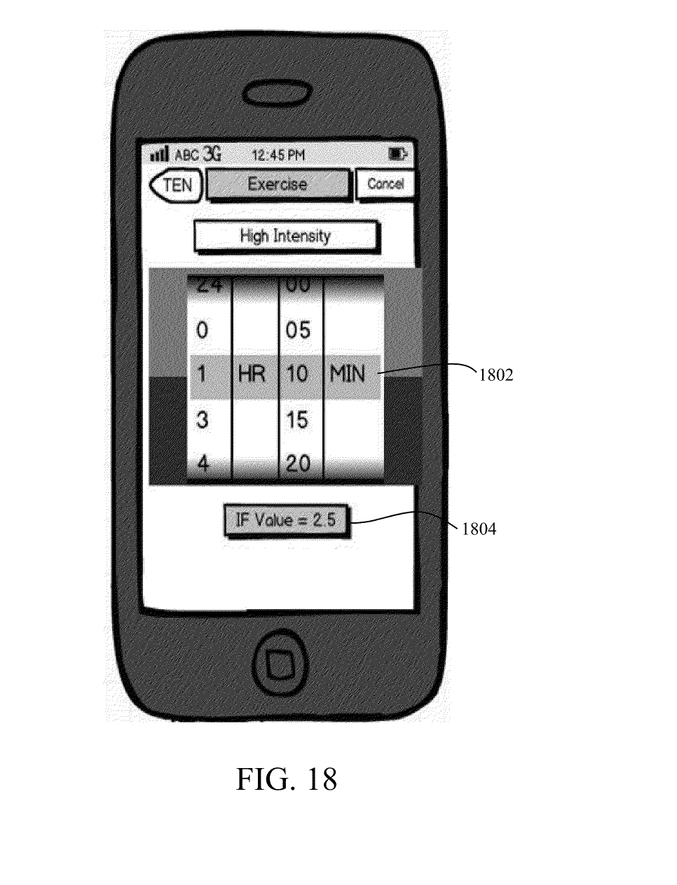

FIGS. 15-18 are elevational views of the front face of the mobile device 100 featuring the wellness application 102 generating a graphical user interface displaying a user selection menu for adding credit values associated with particular activities. The user selects “DO” 108, as shown in FIG. 3. The user then selects “Add Activity” 1502 as shown in FIG. 15. The user is then prompted to add one or more activities. For example, the user may select exercise 1602, as shown in FIG. 16. Because exercise is performed at different intensity levels 1704, 1706, the user is capable of selecting an intensity level 1702 of an exercise, as shown in FIG. 17. For example, the user might select high intensity 1704 or low intensity 1706. Additionally, as shown in FIG. 18, the user may select the duration 1802 of the activity 1602. Based on the user's selection, an IF Value is displayed to indicate the total credit value earned for the particular activity. For example, the user might select exercise 1602, at a high intensity 1704, for a total duration 1802 of one hour and ten minutes (1:10) which could provide an IF value of two point five (2.5) credits 1804 towards the total credits earned 104 (FIG. 16-18).

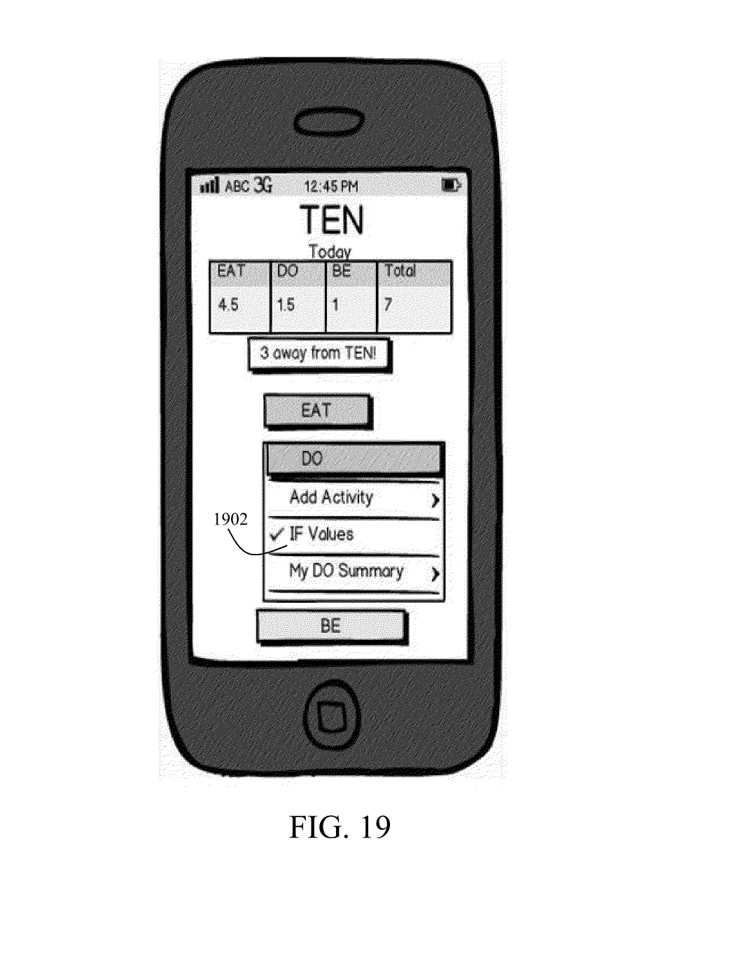

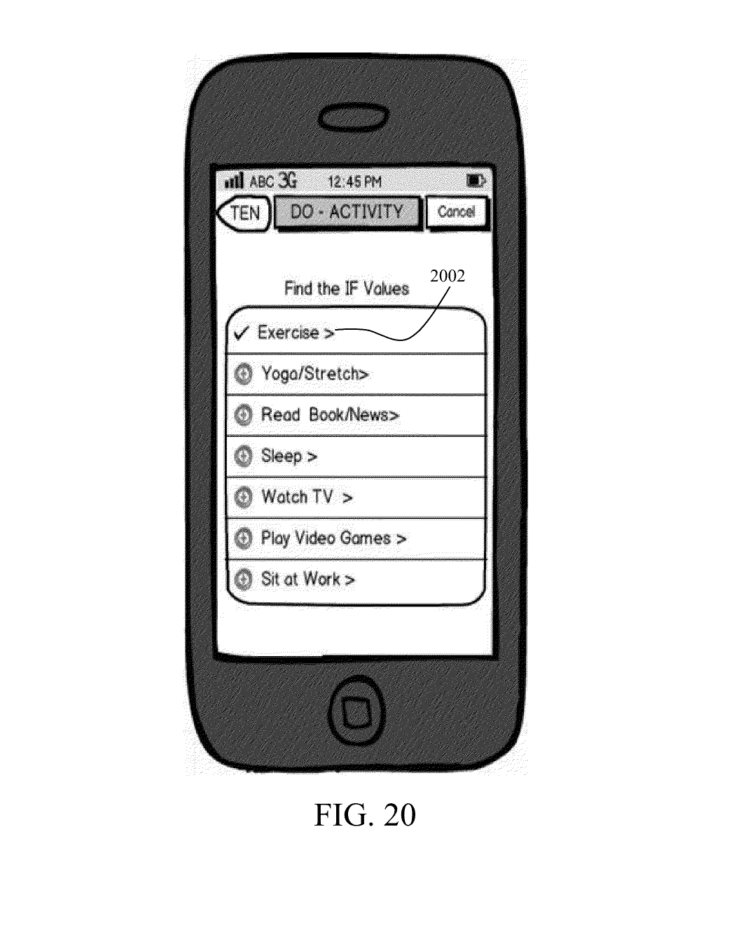

FIGS. 19-21 are elevational views of the front face of the mobile device 100 featuring the wellness application 102 generating a graphical user interface displaying a user selection for determining IF Values of particular activities. The user first selects “DO” 108 from the menu shown in FIG. 3. The user selects IF values 1902 as shown in FIG. 19. The user is then prompted to select particular activities 2002, as shown in FIG. 20.

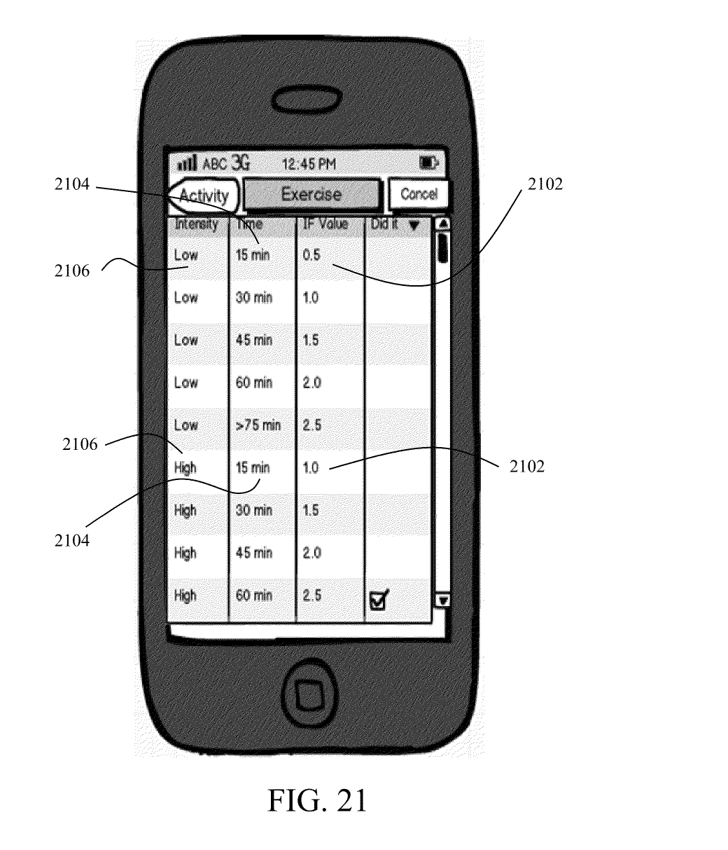

Intensity may be depicted as low, medium or high. Alternatively, intensity may be depicted as any numerical value capable of depicting the intensity, such as an intensity value between one (1) and ten (10). FIG. 21 depicts where a user can modify the IF Value 2102 for a particular exercise 2002. This exemplary screen shot shows low and high intensity exercises 2106 with a time 2104 associated with each.

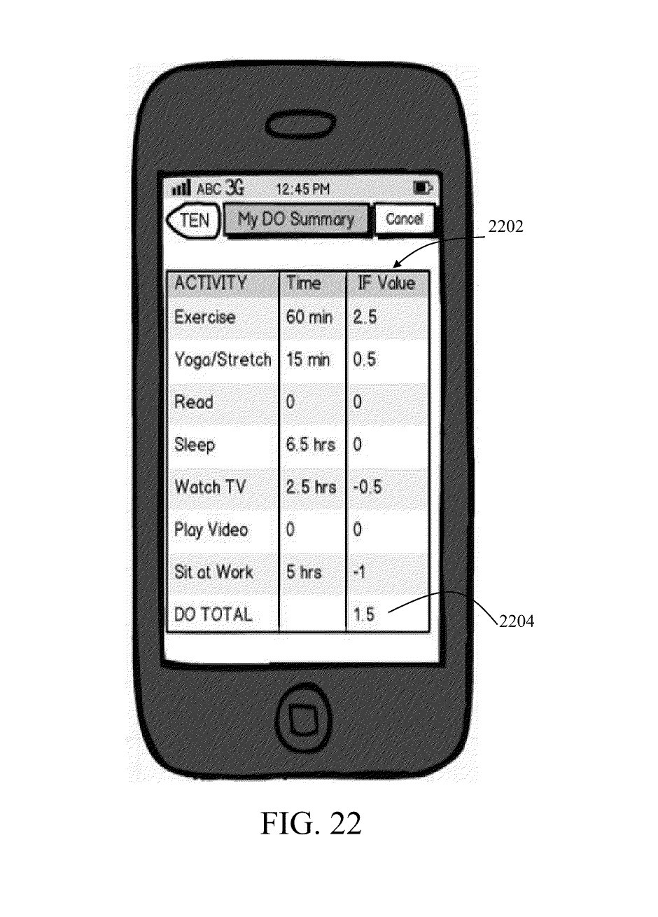

FIG. 22 is an elevational view of the front face of the mobile device 100 featuring the wellness application 102 generating a graphical user interface displaying a summary 2202 of activities performed by the user. The particular activities are shown along with the duration of the activity and the IF Value associated with the activity. The credits assigned to each activity can be dynamically calculated based on the activity and the time the activity is performed. For instance, a particular credit value, e.g., one (1) can be assigned for running a mile. Only a credit value of half (0.5) is associated with running two (2) miles, and a quarter (0.25) for a third mile. This is based on a diminishing returns calculation. A diminishing returns calculation is a method of assigning differing values to the same item based on one or more factors. For example, eating one or two apples has a positive wellness impact and is good; eating 15 apples in one sitting may have a negative wellness impact and is not good. Therefore, the first apple would score a higher credit than would the fourth. As another example, if a user runs one (1) mile, the wellness impact may be greater than would be the last mile of a five-mile run. Therefore, the first mile would score a higher credit value than the fifth. Additionally, frequency of the exercise can impact the credits assigned, e.g., more credit for a first exercise in a long time than for one exercise in a regular and frequent workout routine.

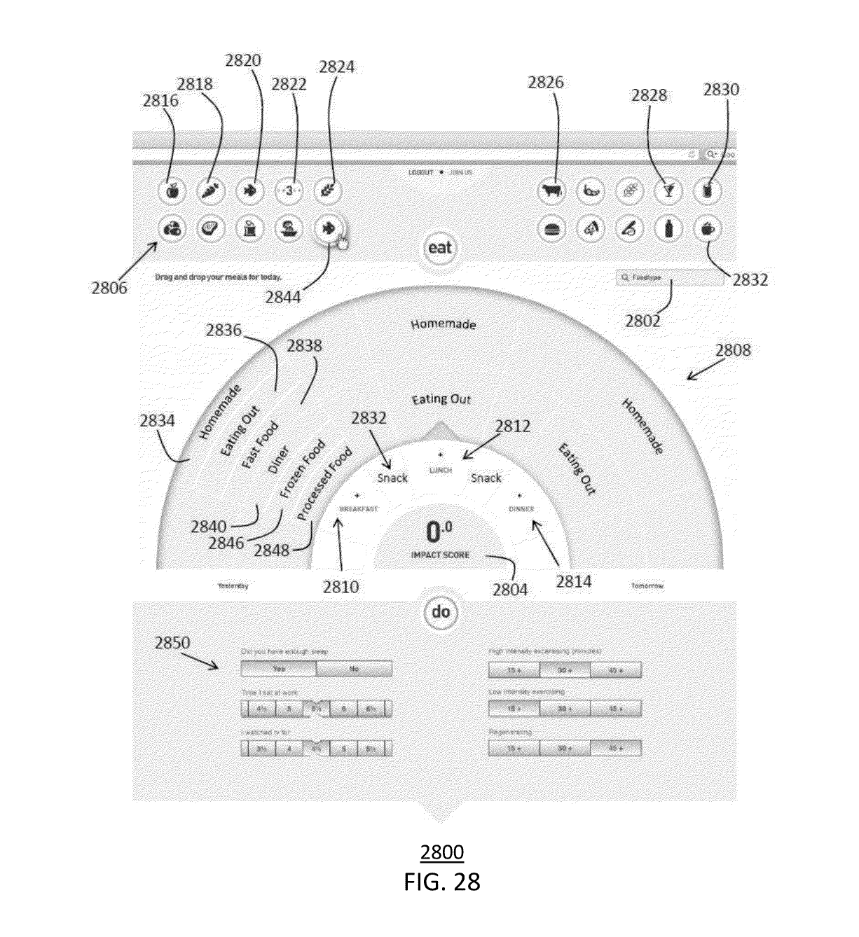

In yet another example how the IF Value may be derived from a diminishing return calculation, using the below-described drag-and-drop feature shown in FIG. 28, a user may drag an impact group icon, e.g., an apple 2816, into a drop section, e.g., 2810 and receive a 1 credit. Based on the amount of apples received in one or more drop sections, the IF Value may increase to a certain maximum value, e.g., 5. The maximum value may be based on, for example, 5 apples being consumed by a user in a given period of time. The overall value of eating an apple may then not increase, i.e., stay neutral, for a certain amount of apples consumed, e.g., 6-7. In certain embodiments, the function may dictate a value that changes from increasing an IF Value directly to decreasing the IF value, i.e., no neutral value given. The overall value of eating an apple may then decrease for a certain amount of apples consumed, e.g., 8-9.

Looking at FIG. 22, a summary 2202 may include the total credit value 2204 associated with the activities performed by the user. The total credit value 2204 is the summation of the total credit value earned for the plurality of activities. Additionally, the item credit value will be subtracted from the target goal 114 (FIG. 1).

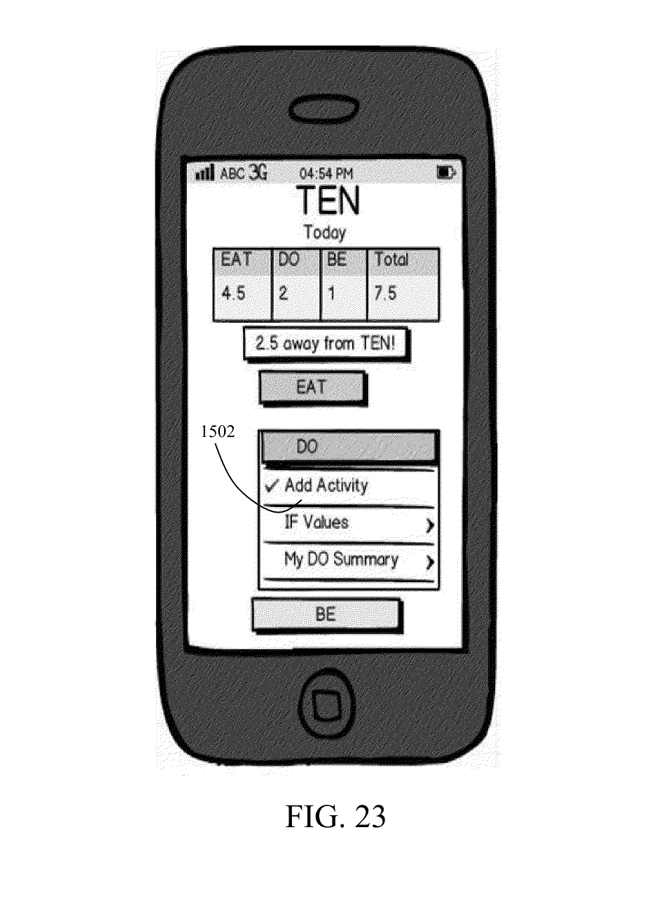

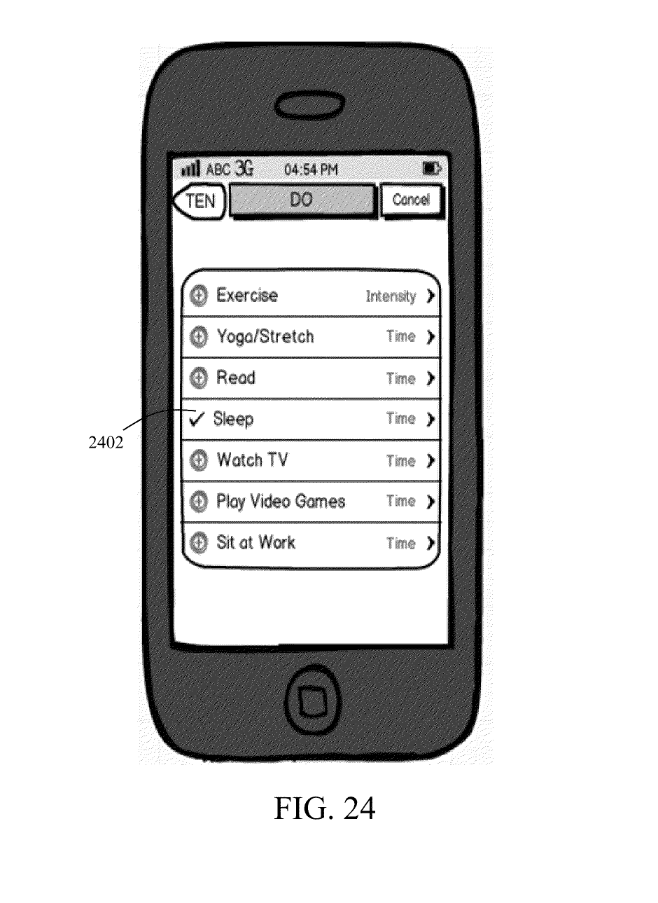

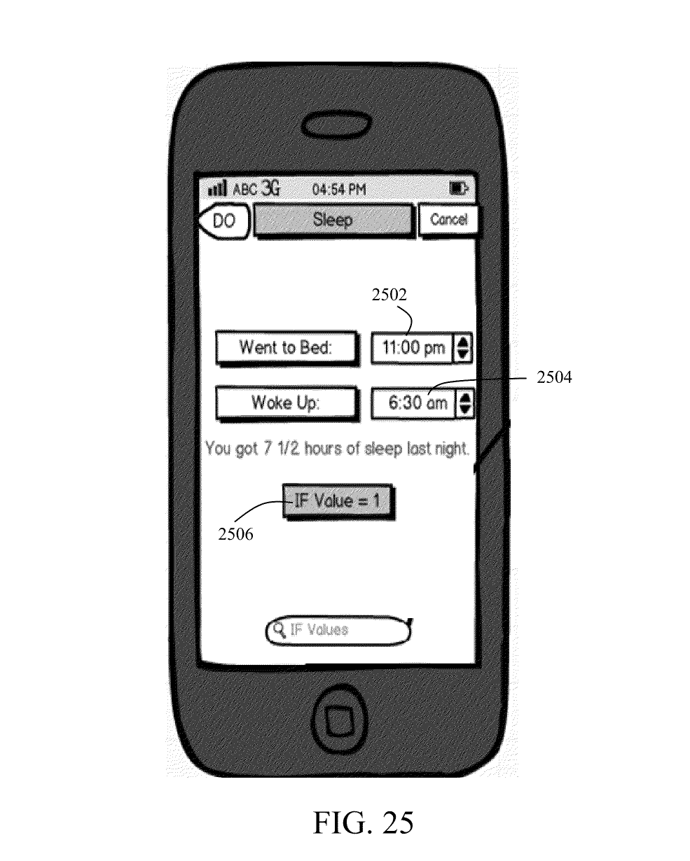

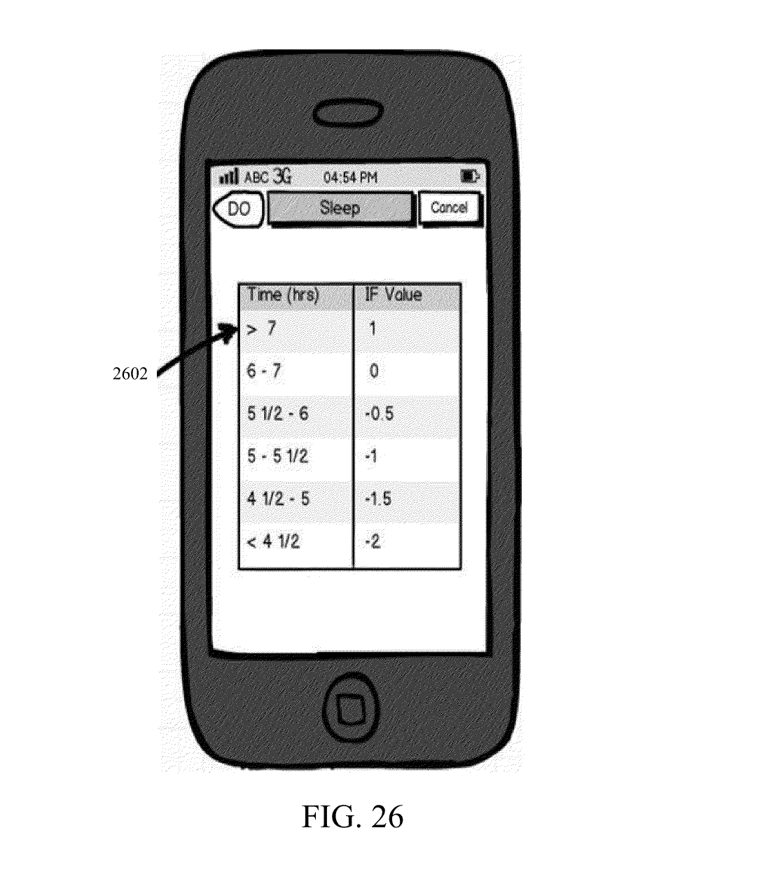

FIGS. 23-26 are elevational views of the front face of the mobile device 100 featuring the wellness application 102 that provides a graphical user interface displaying a user selection for adding credit values associated with particular activities. The user selects “DO” 108, as shown in FIG. 3. Next, the user selects “Add Activity” 1502 from the menu shown in FIG. 23. The wellness application 102 then prompts the user to add particular activities. For example, the user may select “Sleep” 2402 from the menu of FIG. 24. Because both the duration and the timing of sleep is important towards overall health and wellness, selection of sleep 2402 provides for the selection of the time that the user went to bed 2502, as well as the time that the user woke up 2504 (as shown in FIG. 25). A credit value is associated with the total duration of the sleep 2504. The user may input the duration of the sleep. Alternatively, the wellness application 102 causes the calculation of the duration of the sleep as relating to the time that the user went to bed 2502 and the time that the user woke up 2504. An IF Value 2506 is associated with the duration of the sleep chosen by the user, exemplified by element 2602 shown in FIG. 26. Further, the IF Value 2506 may be calculated in relation to the quality of the sleep. For example, the IF Value may increase by any value, such as zero point five (0.5) credits, for good quality sleep. As another example, the IF Value decreases by any value, such as zero point five (0.5), for a poor quality sleep. Further, the credits can exponentially increase or decrease based on the differential between the ideal sleep time and the user. For example, maximum credits can be assigned if the user sleeps 8 hours. Additional credit may be assigned for sleeping more than 8 hours, but the additional credit will not scale. For example, if the credit for sleeping eight (8) hours is two (2) credits, the score for sleeping nine (9) hours will not equal 2.25, i.e., will not be equal to the 8 hour credit divided by 8. This again, follows the theory of diminishing returns.

It should be understood that while the wellness application references particular food items or groups, user selections may be replaced with pictures, icons or other colors codes to communicate information to the user without departing from the spirit of the invention.

In one embodiment, the wellness application 102 is configured to encourage healthy behaviors and actions through feedback of impact of both healthy and unhealthy (1) foods, (2) activities, and (3) behaviors. The wellness application 102 determines a baseline that is used to encourage healthy behaviors. For example, an initial questionnaire may be provided to a user to calculate the baseline. An exemplary questionnaire may request input relating to:

a. Age

b. Height

c. Weight

d. Do you currently smoke?

e. Do you currently eat seafood/fish?

f. If yes, how many times per week?

g. If no, would you eat seafood/fish?

h. On average, how many hours of sleep do you get per night?

i. On average, how many hours of TV do you watch per day?

j. How many hours per day do you sit at work?

k. Do you eat breakfast every morning?

l. Do you eat a piece of fruit every day?

m. Do you eat a vegetable every day?

n. What is the average number of alcoholic drinks that you consume per week?

o. How often do you eat dinner at a restaurant per week?

p. How often do you eat take-out food each week?

q. Do you drink soda?

r. If yes, how many per week?

s. How much exercise do you perform each week?

t. Do you walk at least 15 minutes every day?

From a questionnaire, the wellness application 102 will show progress and improvement immediately upon beginning the wellness program because the initial information received from the questionnaire will act as a baseline. The progress and improvement may be depicted as a bar graph or some other type of chart. Based on the questionnaire responses, the wellness application 102 suggests foods, activities and behaviors that will allow the user to reach their stated goals. The suggestions may come in the form of alerts to indicate, encourage or otherwise remind the user to reach their goal. Alerts may be text messages, pop-up messages, sound alerts, or any other type of alert capable of alerting or encouraging a user.

In another embodiment, alerts may be generated by the wellness application 102 to encourage and help the user to reach any particular goal stated herein. In an example, the alerts may be based on foods previously consumed and logged. The wellness program 102 will alert the user suggesting the consumption of a particular food item that will help the user reach a particular goal. Alternatively, the alerts may be based on past activities performed and/or past behaviors. In one example, the alerts are based on prior known activities and/or behaviors of the user that evidence a statistically higher likelihood that the user will perform that activity or behavior and thus allow the user to reach a particular goal.

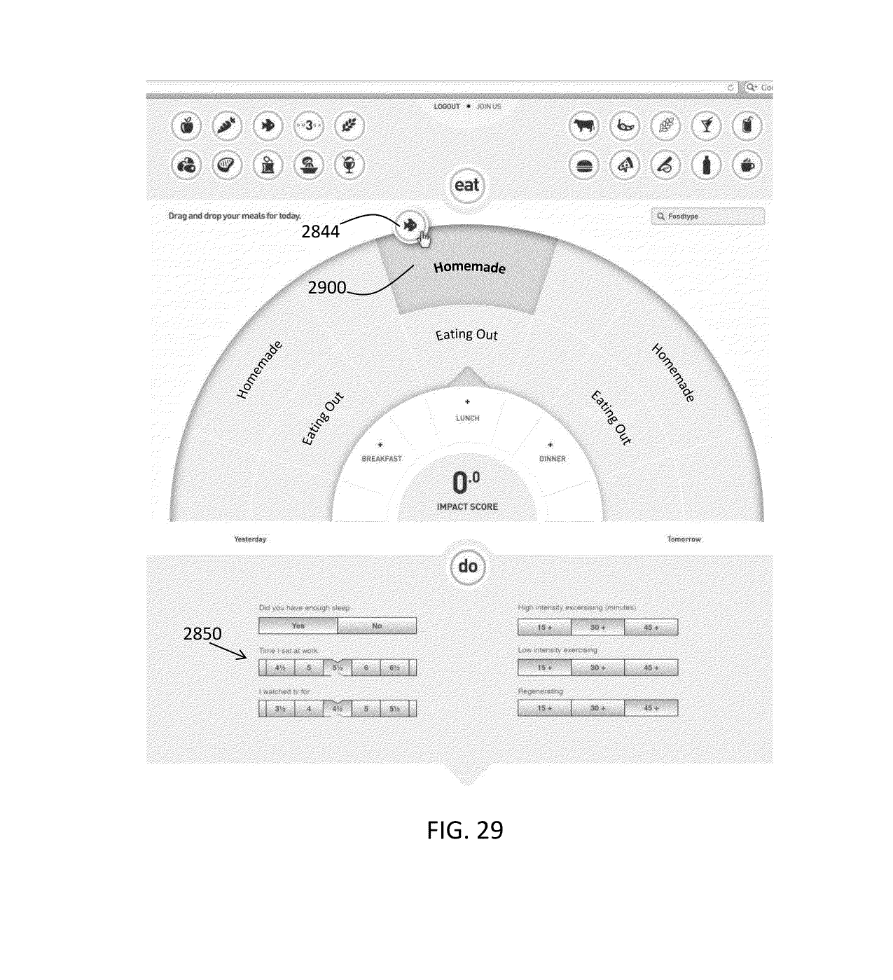

Referring now to FIGS. 28-29, screen shots depicting visual embodiments are shown generated from a system and method for improving human wellness. More specifically, the system and method utilizes a drag-and-drop weight management tool viewed in a graphical workspace utilizing a graphical user-interface. User interfaces are known by those skilled in the art and may work in conjunction with various operating systems. The graphically workspace may be any space where a user can directly manipulate one or more graphical elements. This advantageously allows the user to quickly and effectively input and monitor their information. The weight management tool selection entry screen 2800 may be accessed through an application. The application may be operated through a smartphone or through a web browser. The weight management tool selection entry screen 2800 may be further configured for touch sensitive user interaction or mouse-click interaction.

A drag-and-drop food item selection menu 2806, depicting a plurality of drag-and-drop impact group icons arranged therein, allows the user to select or otherwise determine information that changes the user's Impact Score. The selection menu 2806 provides a quick list of commonly used food group items. In other embodiments, the menu 2806 may also display other drag-and-drop impact group icons. In one embodiment, one or more of impact group icons are arranged, i.e., differentiated, in relation to other group icons of different class. For example, at least one of the plurality of food items are placed apart from at least one of the plurality of user behaviors to effectuate quick user-recognition of a particular icon. In other embodiments, every possible food group item is displayed to the user or the food group items may be displayed based on the user's commonly eaten food group items over a period of time. The Impact Score display portion 2804 calculates and adjusts the Impact Score after the user selects or otherwise identifies one or more of the drag-and-drop icons, e.g., a food or drink item, and places it within a drop section 2808. As such, the Impact Score display portion 2808 can be said to “update” after the receipt of one of the drag-and-drop icons in a drop section.

Each of the plurality of drag-and-drop impact group icons, e.g., 2816, can be seen displayed as an image symbolizing one or more plurality of food items, a plurality of user behaviors, and a plurality of user activities. For example, icon 2816 may represent or symbolize a fruit group. In other embodiments, icon 2816 may, more specifically, represent an apple. Utilizing an image that symbolizes a foot item, user behavior, and/or user activity, permits the user to quickly and efficiently identify the same and account for said icon's usage.

Still referring to FIGS. 28-29, a simplified system and method for tracking impact items such as food items, which may include both food and drinks, user activities, and user behaviors are shown. The selection menu 2806 permits users to select and add food impact items or drink impact items by dragging and dropping said items onto the impact region 2808. Said another way, the impact region 2808 has a plurality of drop sections (e.g., 2810) that receives a user selection (e.g., fruit 2816) from at least one of the plurality of impact group icons. The food impact icons/items, which may include drink impact items, provide a simplistic representation of food impact items. For example, the food impact items may include fruit 2816, vegetables 2818, fish 2820, omega-3 2822, grain 2824, dairy 2826, alcohol 2828, soft drinks, 2830, and coffee 2832, just to name a few. Thus, a user does not have to select and/or drag and drop the exact item of consumption in order to track the effects on the user's health. Instead, the user selects and/or drags and drops the food impact item, which may include the food group associated with a consumable food. In some embodiments, the impact groups are based on the USDA defined food groups that includes fruits, vegetables, grains, proteins, and dairy. In some embodiments, the impact groups are uniquely defined within the system, which allows for non-traditional impact groups, such as alcohol, coffee, tea, and desserts, to name just a few. In some embodiments, the food or drink items that are grouped within a particular food group is based on an IF Value of the item or items within the group. It is expressly noted that the instant food log is not a calorie counter, but instead estimates the impact that a particular quantity of food from one or more impact groups will have on the user's overall health. As further disclosed herein, the present embodiment simplifies the user's ability to select the food that they ate.

In one exemplary embodiment, the impact region 2808 is divided into sections 2810, 2812, 2814, 2832. These sections may include and be labeled as breakfast 2810, lunch 2812, dinner 2814, and/or snack 2832. In other embodiments, there may be more or less sections than depicted in FIG. 28. The impact region 2808 allows the user to drag-and-drop the impact items into a section. In one embodiment, one or more of the sections 2810, 2812, 2814, 2832 are formed with two or more sub-drop sections. These sub-drop sections may include, for example, a non-commercial food seller, i.e., “homemade” drop section 2834 for food cooked at home (or its equivalent, i.e., “eating in”) or commercial food seller drop sections. Examples of commercial food sellers drop downs are “eat out” drop section 2836 for food from a restaurant, fast food drop section 2838 for fast-food restaurants, fine dining drop section 2840 for fine dining establishments, diner drop section 2840 for diners that serve classic diner food, frozen food drop section for frozen meals and food from the frozen food section of a grocery store, processed food section 2848 for foods that are processed, such as cereals and store bought cookies.

It is recognized that some of the above sub-drop sections encompass in scope some of the other sub-drop sections (e.g., “eating out” and “fast food”). Said sub-drop sections are only demonstrative and signifies the diverse and broad application of the inventive process. In some embodiments, when the user drags and drops a food group item from the menu 2806 into one of the drop sections, an IF Value is calculated based on the particular food group item that is dropped into a particular drop section. For example, if a user drags a fish impact group icon 2844 from the menu 2806 and drops that icon 2844 in the fast food section 2838, a first IF Value is calculated and associated to the user. The user may additionally input the number of servings of the food group items that are consumed in accordance with the teachings of the present invention discussed herein.

In addition, the Impact Score is updated in relation to the first IF Value that is calculated. For another example, if a user drags the fish impact group icon 2844 from the menu 2806 and drops it into the homemade section 2834, a second IF value is calculated and associated to the user. In the two identified examples, with all other elements being equal including the serving size of fish food group 2844, the first and second IF value would be different because the value of a fast food fish would be estimated to have a lower IF value than would homemade fish. All else still being equal, the IF Value of the homemade fish may be associated with a positive value whereas a fast food fish item, frozen food fish item, and/or a diner fish item may each, for exemplary purposes, be associated with a negative IF value. Accordingly, the IF Value and the Impact Score 2804 are calculated and adjusted based on the overall health and wellness value of the food consumption instead of merely adding the calorie content. In other words, this system and method provides a simplified and accurate measure of the estimated health and wellness value through a drag-and-drop based food log.

Still referring to FIGS. 28-29, the food and drink items are simplified to allow for quicker and more convenient determination of what foods should be added to the impact region 2808 than is possible with the prior art. As such, the weight management tool can readily be observed and appreciated as providing a simplified and effective process over those known systems and methods that are invariably tedious and monotonous.

Still referring to FIGS. 28-29, a user may type into a search box 2802, or otherwise supply, food entry information, for determining the impact items for a food item that the user ate, is eating, or will eat. Further, the user may associate an IF Value associated with the one or more impact items/icons, as described herein. In other embodiments, the particular impact icon may be received through voice recognition software available on the device 100. Alternatively, the food icon may be selected from past searches or past food entries in accordance with the principles of the present invention. The user may remove the fish icon 2844 and place it in one or more of the sections 2810, 2812, 2814, 2832. As depicted in FIG. 29, the at least one of the plurality of sections 2810, 2812, 2814, 2832 is the “Homemade” section 2900. The selected section in which the icon (e.g., 2844) is dropped may also be highlighted or otherwise indicated with other visual (e.g., lights or colors) or oral means (e.g., with an alert or oral description through a speaker communicatively coupled with the device 100).

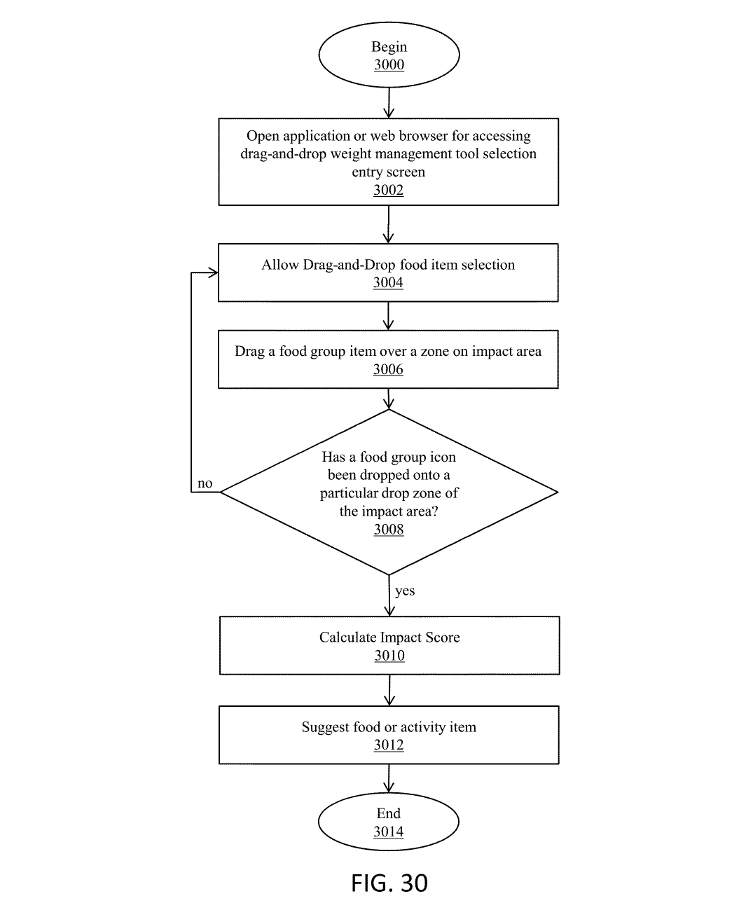

Furthermore, as illustrated in FIGS. 29 and 30, the graphical workspace may also include sections where the user can input data concerning activities, i.e., the “DO” section 2850. Therefore, the user may input or be prompted for information concerning his or her activities effectively and efficiently on one screen and/or without any textual input. In other embodiments, the graphical workspace may also include a section for behavioral input, i.e., “BE,” or any combination of the above.

Referring now to FIG. 30 is a process flow diagram depicting an exemplary method for improving human wellness as illustrated in the screen shots of FIGS. 28-29. The process starts at step 3000 and immediately proceeds to step 3002 wherein the user opens an application or web browser for accessing a weight management system having a drag-and-drop weight management tool selection entry screen. In some embodiments, the user interacts with the entry selection screen via a touchscreen device. In other embodiments, the user interacts with the selection entry screen via eye movements, voice commands, or through another external input device (e.g., mouse). In additional embodiments, the impact group icons may have a drop down selection box associated therewith that enables an impact group icon to be moved to a desired drop section. At step 3004, the selection entry screens permits the user to select food group icons that are operable to be placed on food drop sections in the impact region for logging food group items consumed by the user. At step 3006, the user drags the selected food group item over a drop section and/or zone on the impact area. At step 3008, the system determines, via a computer processor, whether a food group item has been dragged and dropped onto a particular drop section or drop zone of the impact area. If the food group icon is released and not otherwise placed into the impact region 2808, the system will continue to allow new selections of food group icons for placement into the impact region 2808.

Alternatively, if a food group icon has been dropped into a particular zone of the impact area, then at step 3010 an IF Value is assigned to the food group item and the impact score is updated and calculated accordingly. In one embodiment, once a group icon is dropped into a particular zone, the user may also be permitted to adjust the serving, interval, or occurrence accordingly. In other embodiments, the user may adjust the same before the icon is dropped into the zone. The system also permits a user to remove the icon out of the impact area, wherein the impact score would adjust accordingly. Similarly, the system will allow the user to select additional food group items to be placed into the impact region 2808 after the score is calculated at step 3010. At step 3012, the system may suggest food, activity, or behavior items in order to further increase the impact score. For example, after logging a fish 2844 from a fast food restaurant 2838, the system may suggest and identify a vegetable 2818 as the next food choice in order to raise the impact score. The system may also suggest exercises to increase the impact score. The system may suggest specific exercises, such as running or pushups, or may simply give a general recommendation to exercise. The system may suggest a particular quantity or a specific time period to perform said exercise, activity, or food consumption or in order to earn a maximum IF Value. The system beneficially creates a visual stimulus and monitoring system to achieve a more healthy and rewarding lifestyle. The process terminates at step 3014.

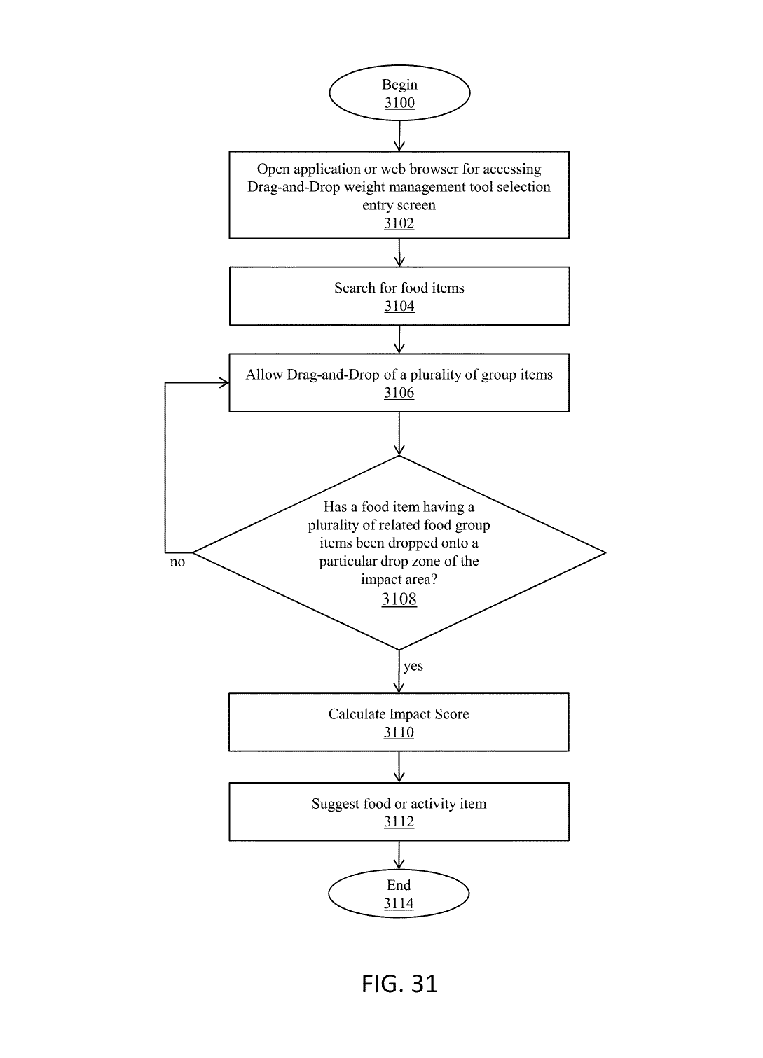

Referring now to FIG. 31 is another exemplary process flow diagram depicting the above-described method of improving human wellness. The process starts at step 3100 and immediately proceeds to step 3102, wherein the user opens an application or web browser for accessing a weight management system having a drag-and-drop weight management tool selection entry screen. In some embodiments, the user interacts with the entry selection screen via a touchscreen device. In some embodiments, the user interacts with the selection entry screen as described above. Following step 3102, step 3104 includes the user searching for a particular food type. In one embodiment, a simplistic search is employed, the simplistic search categorizing the food (e.g., by type). This eliminates the need to search for the identical and specific food item that was consumed or to search a large database that has specific food items from a plurality of brands. For example, the user simply needs to search for a hamburger instead of searching for a specific brand of hamburger. Food impact icons will be displayed as a result of searching for a food type.

In another embodiment, the search engine may also be operable to permit the user to search for a particular impact group that is associated with an individual food, activity or behavior. For example, if the user does not know how to log a granola bar he or she would enter “granola bar” into the search field. In return, the results for that search would indicate “whole grain,” the impact group it belongs to, next to or in close relation to the word “granola bar.” The search results may also show the appropriate serving size or interval associated with a particular impact group. So in the granola bar example, the search would display “granola bar, 1 bar (40 g), whole grain icon, +0.5.”

A user can select the specific food impact icons that are associated with the food type for that particular meal. For example, if the user searches for a hamburger, the user is presented with food impact icons such as lettuce, onions, and tomatoes, or alternatively may be simply presented with a vegetables food impact icon selection. Additionally, the user may be presented with a condiment food impact icon. As such, the user can select the food impact icons that were consumed with the meal. At step 3106, the user is permitted to drag-and-drop one of the plurality of food impact icons. The selection entry screen(s) permits the user to select food group icon to be placed on food drop sections for logging food group items consumed by the user. The process continues to the steps 3108, 3110, 3112, as described above for FIG. 30. The process terminates in step 3114.

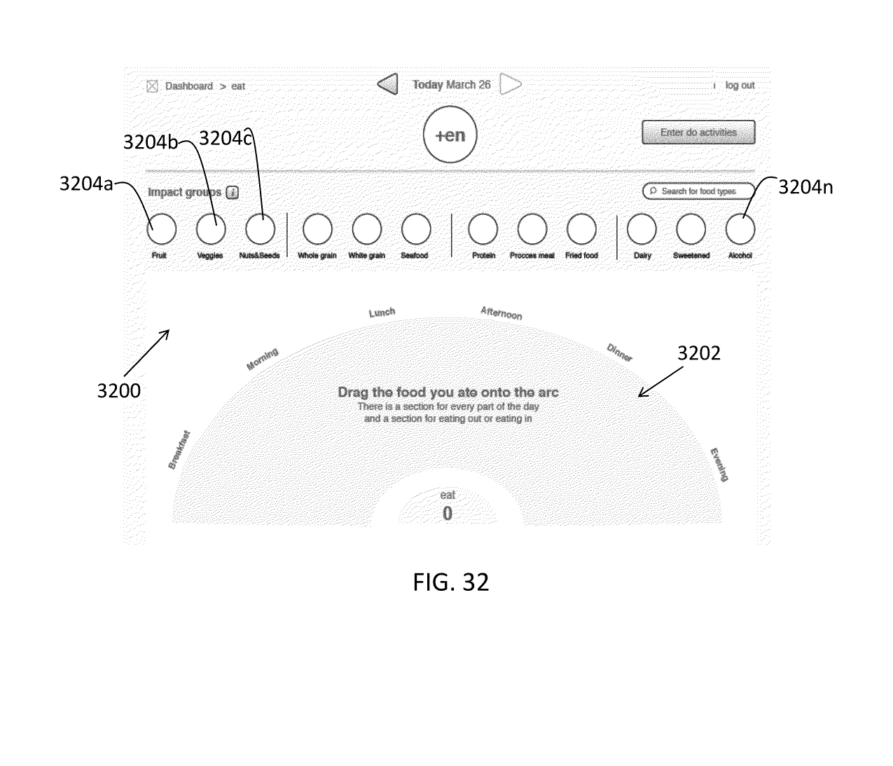

Referring now to FIGS. 32-35, exemplary screen shots are shown depicting various drag-and-drop user-movements within a weight management tool application in accordance with an embodiment of the present invention. The workspace 3200 can be seen having drag-and-drop food icons and/or impact group icons that are operable to be placed in an impact region 3202 defined within the workspace 3200. As described above, each one of the plurality icons 3204a-n (with the letter “n” connoting a number determined by the user) has an associated IF Value, also referred to as an “impact value” based on the quantity and quality of the particular icon selected by the user. The plurality of icons 3204a-n shown in FIGS. 32-35 represent a categorical arrangement of foods (e.g., 3204a, Fruit) for the user to select based on the consumed food. These icons 3204a-n (including their IF Value(s)) may be defined by the administrator (in accordance with generally known and/or accepted methods known in the art) or may be user-defined. As such, the user beneficially is not required to search for a specific consumed food, any yet he or she is ultimately provided with an impact score to facilitate the user in making smarter health and life choices.

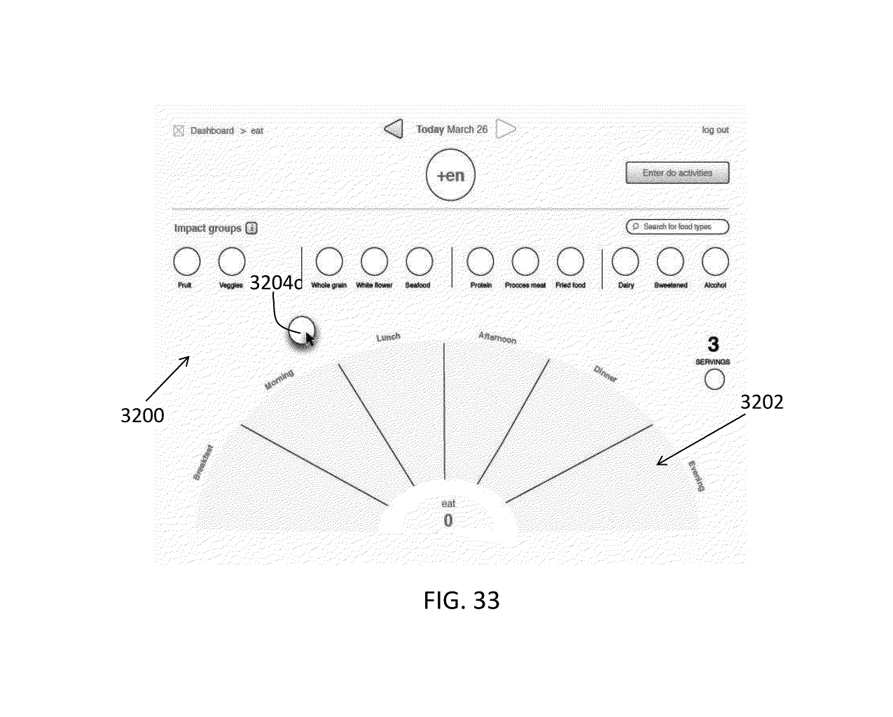

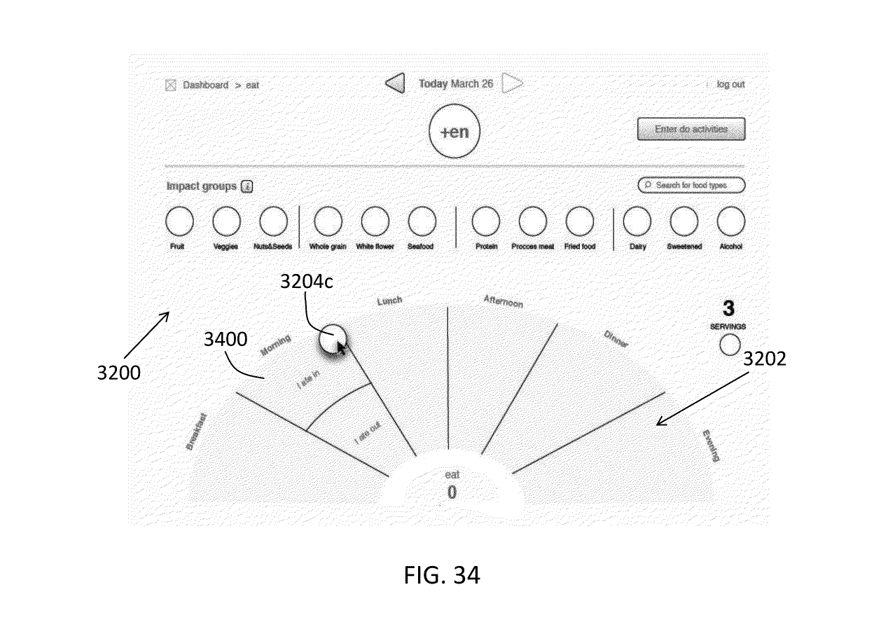

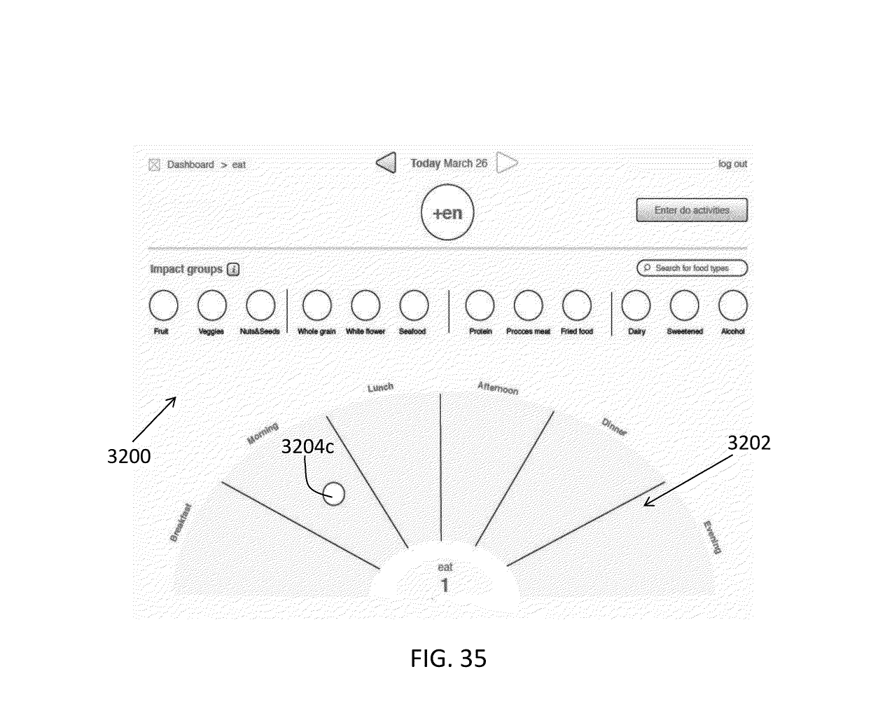

As shown in FIG. 33, the user can touch or click on an impact group icon 3204c and drag that icon 3204c onto the impact region 3202. As the user drags the impact group icon 3204c onto the impact region 3202, the user has the opportunity to choose a particular drop section where the icon 3204c is dropped, e.g., the time period of the day in which the food was consumed. This enables the user to track and monitor when and what he or she ate on a specific date/time. As shown in FIG. 34, the user may drop the impact group icon 3204c in a drop section 3400 that corresponds to the user “eating in.” Again, as discussed above, the IF Value of the food group item may depend where the food group icon 202 is dropped, i.e., “eating in” or “eating out.” FIG. 35 shows a food group icon 3204c after it has been dropped into the impact zone 3202. In one embodiment, the drop sections may highlight or illuminate when the user places the icon 3204c over or scrolls over a particular section. In further embodiments, a sub-drop section (e.g., “eating in”) may only be displayed or illuminated after the user places the icon 3204c over or scrolls that particular sub-drop section. The servings of the particular food or other group designated by the icon 3204c may be manually inputted by the user or may be dictated by the amount of times the icon 3204c is placed in the same drop zone. The Impact Score is calculated, adjusted, and displayed on the user's device based on which drop zone the user drops icon 3204c.

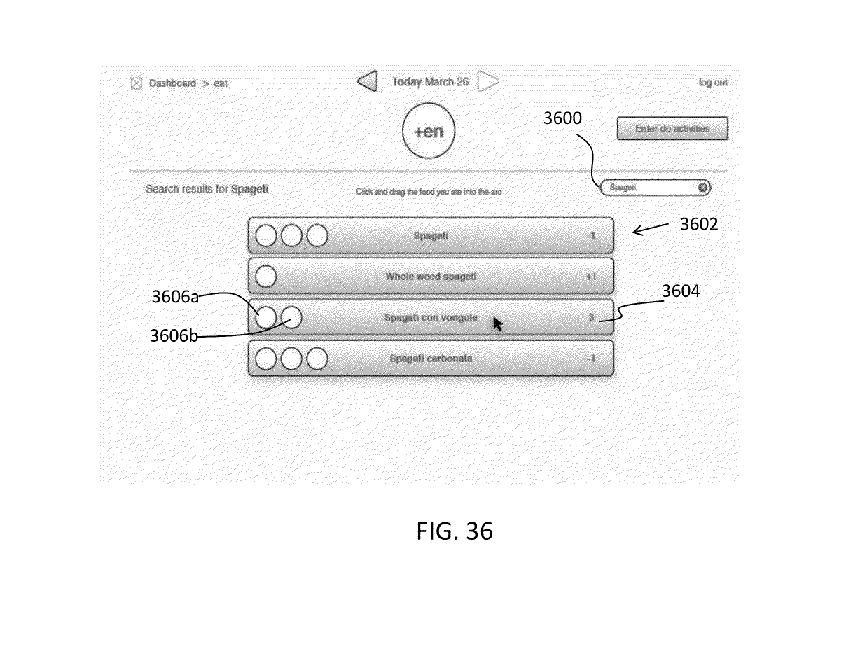

With reference now to FIGS. 36-38, exemplary screen shots are shown depicting a search result from a user search and various drag-and-drop user-movements using the results from that search within a weight management tool application in accordance with an embodiment of the present invention. FIG. 36 depicts a food type search whereby the user enters a food type, i.e., a user input, in the food type search bar 3600 and a simplistic list of food items 3602, which may be impact group drag-and-drop icons, is populated and displayed to the user. The list 3602 is simplistic because it does not contain specific brands and specific items, but instead provides generic food items. The populated list 3602 allows the user to drag and drop one or more food items from the populated list 3602 onto an impact zone 3702 defined within a graphical workspace 3700. The populated list 3602 may display an IF Value (e.g., 3604) of a particular food item located on the list 3602, thereby enabling the user to make a food consumption choice based on the IF Value of the food. The IF Value 3604 of a food item is calculated based on the controls of the food log or as otherwise described herein. For example, the IF Value 3604 for spaghetti con vongole may vary depending on previously entered EAT 106, DO 108, and BE 110 inputs.

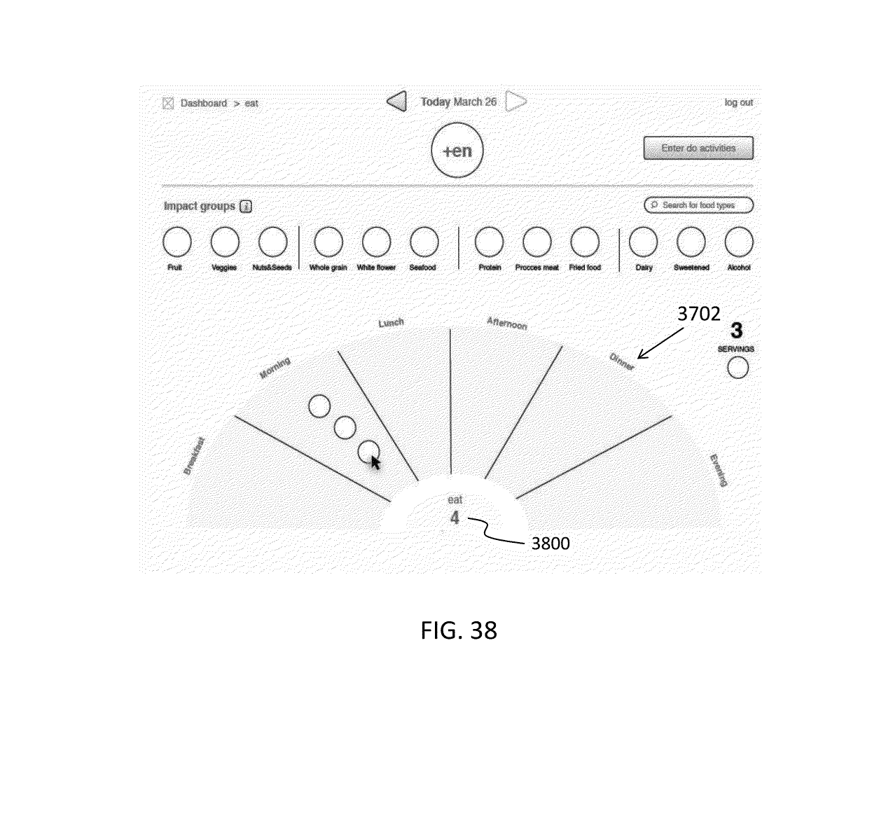

In some embodiments, selecting a food icon will automatically determine which impact group icons 3606a-b are associated with the food item. This allows the user to more effectively and efficiently calculate the IF Value, and ultimately, the impact score. Said another way, if a particular consumed food item encompasses multiple icons it will be reflected as such. In some embodiments, the user is additionally able to select which icons were consumed as part of the food item, in which case the system will then associate the proper impact groups as a result of selecting individual foods consumed with the food item. For further example, if the user searches for a hamburger, the list may populate with food items including without limitation, beef hamburger, turkey hamburger, and veggie burger. By selecting on any of the burgers, the user can then select which food items were eaten as part of the food item, such as lettuce, onions, tomatoes, ketchup, and mayonnaise. The impact group icons associated with the user-consumed foods are automatically populated to the food item, thus the user does not have to independently determine which impact groups to associate with each food item. Additionally, the proper impact group icons are added to the impact region 3702 when the food item is dropped onto the impact region 3702 (as shown in FIG. 38).

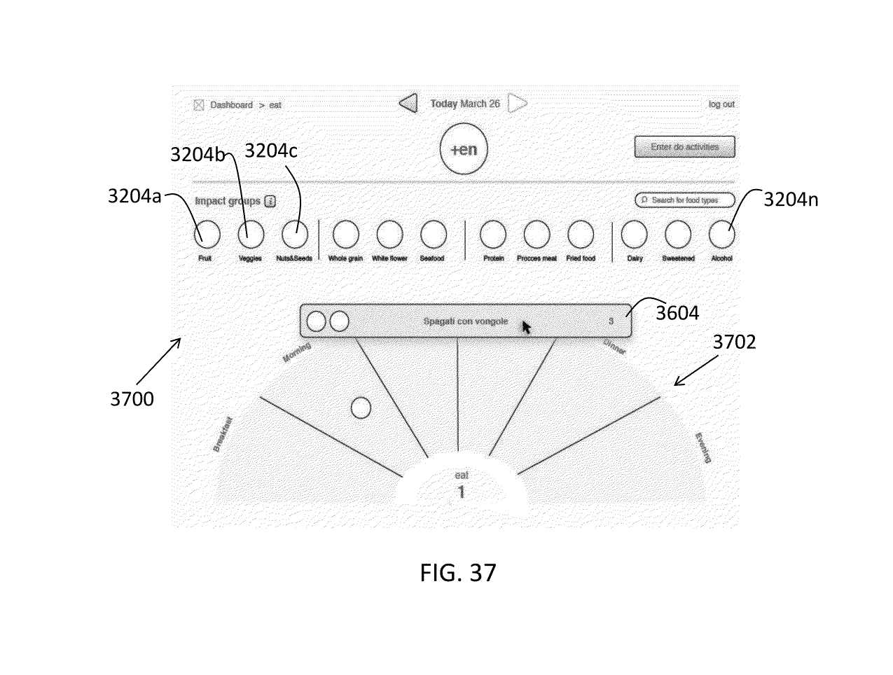

FIG. 37 shows the next sequence where the user drags the spaghetti con vongole to the impact region 3702. Next, FIG. 38 shows the impact region 3702 after the user drops the spaghetti con vongole into the impact region 3702, whereby the impact score 3800 is updated and reflected on the screen.

What is claimed is:

1. A process for improving human wellness, the process comprising the steps of:
receiving at a processing device at least one input based on at least one of a user consumed food, a user activity, and a user behavior;
relating a value to each of said at least one input, each value being one of a positive, a negative and a neutral value and derived by a diminishing return calculation that assigns a value to an n^{th} occurrence of the at least one input that has a sign opposite to a value assigned to a first occurrence of the at least one input;
calculating, based on each value, a total credit value; and
causing the processing device to display a value related to the total credit value.

2. The method of claim 1 wherein the negative value reduces the total credit value in relation to a target goal.

3. The method of claim 1 wherein the positive value increases the total credit value in relation to a target goal.

4. The method of claim 1 wherein the value is assigned based on a measurement of an amount of the user consumed food.

5. The method of claim 1 wherein the value is assigned based on a nutritional quality of the user consumed food.

6. The method of claim 1 wherein the value is assigned based on a characteristic of other food consumed by the user.

7. The method of claim 1 wherein the value is assigned based on a time of day the user consumed food is consumed.

8. The method of claim 1 wherein the value is assigned based on at least one of a location where the user consumed food is purchased and a location where the user consumed food is consumed.

9. The method of claim 1 wherein the value is assigned based on duration of the user activity.

10. The method of claim 1 wherein the value is assigned based on an intensity level of the user activity.

11. The method of claim 1 wherein the value is assigned based on an intensity level of the behavior.

12. The method of claim 1 wherein the value is assigned based on a duration associated with the behavior.

13. The method of claim 1 wherein the diminishing return calculation assigns less value for a second occurrence of at least one of the user consumed food, the user activity, and the user behavior than for a first occurrence of the user consumed food, the user activity, and the user behavior.

14. A method for tracking health and wellness of a person, the method comprising the steps of:
receiving at a processing device a plurality of inputs based on a combination of at least one user consumed food, at least one user activity, and at least one user behavior;
relating at least one positive value to one of the plurality of inputs;
relating at least one negative value to one of the plurality of inputs;
calculating a total credit value based on the positive and negative values, the total credit value reduced in relation to the at least one negative value; and
causing the processing device to display a value related to the total credit value.

15. A computer-implemented method for improving human wellness, the method comprising:
electronically displaying an arrangement of a plurality of drag-and-drop impact group icons in a graphical workspace, at least one of the plurality of drag-and-drop impact group icons corresponding to at least one of a plurality of food items, a plurality of user behaviors, and a plurality of user activities;
defining an impact region in the graphical workspace, the impact region having a plurality of drop sections, the impact region configured to receive the plurality of drag-and-drop impact group icons;
receiving a user selection of the at least one of the plurality of drag-and-drop impact group icons in at least one of the plurality of drop sections;
determining an impact factor value based on which of the at the least one of the plurality of drop sections receives the user selection of the at least one of the plurality of drag-and-drop impact group icons; and
determining, based on the impact factor value, an updated impact score.

16. The computer-implemented method of claim 15, further comprising:
electronically displaying the user selection of the at least one of the plurality of drag-and-drop impact group icons in the at least one of the plurality of drop sections.

17. The computer-implemented method of claim 15, wherein:
the drag-and-drop impact group icons are displayed as an image symbolizing the at least one of a plurality of food items, a plurality of user behaviors, and a plurality of user activities.

18. The computer-implemented method of claim 15, wherein:
the at least one of the plurality of the drag-and-drop impact group icons corresponds to at least one of a plurality of categorized food groups.

19. The computer-implemented method of claim 15, further comprising:
displaying a maximum available impact factor value for increasing the updated impact score, the maximum available impact factor value based on an amount of the plurality of drag-and-drop impact group icons received in the at least one of the plurality of drop sections.

20. The computer-implemented method of claim 15, further comprising:
electronically receiving a user input in a search bar, the user input corresponding to the at least one of the plurality of food items, the plurality of user behaviors, and the plurality of user activities;
populating an item list, based on the user input, for display to the user; and
presenting the item list to the user, the item list including the plurality of drag-and-drop impact group icons configured for movement by the user.
